(19) United States
(12) Patent Application Publication
(10) Pub. No.: US 2002/0000979 A1
(43) Pub. Date: Jan. 3, 2002

(54) Touch panel, method for manufacturing the same, and screen input type display unit using the same

(76) Inventors: Shoji Furuhashi, Mobara (JP); Shigeki Suzuki, Funabashi (JP); Shinsaku Chiba, Mobara (JP); Kazuo Majima, Mobara (JP); Yasuaki Kondou, Kimistu (JP); Kazuo Ishii, Mobara (JP); Kazutoshi Yoshida, Mobara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/883,926

(22) Filed: Jun. 20, 2001

(30) Foreign Application Priority Data
Mar. 5, 2001 (JP) 2001-059515
Jun. 28, 2000 (JP) 2000-194112

(51) Int. Cl. G09G 5/00

(52) U.S. Cl. 345/173

(57) ABSTRACT

A method for manufacturing a touch panel, comprising the steps of adhering an upper substrate and a lower substrate to each other, said upper substrate being made of a soft film member with an upper resistance film, said lower substrate being made of a hard plate with a lower resistance film; and subsequently cutting off said upper substrate and said lower substrate.

### BACKGROUND OF THE INVENTION

1. Field of the invention

The present invention relates to a touch panel for detecting input coordinates through a change of resistance caused by depression or depressing operation; a method for manufacturing the touch panel; and a screen input type display unit constituted by laminating the touch panel.

2. Description of the Related Art

A touch panel is used as means for inputting characters/digits or images by the depression by a finger or a pen point. In addition, the touch panel is laminated on the display surface of a display unit such as a panel type display or CRT so as to be used as means for selecting information displayed on the display surface or inputting characters/digits or images.

As display units for use as display means of personal computers, portable information terminals, or monitors of other information apparatus, there are known panel-type display units using liquid crystal panels, organic EL panels or plasma panels, etc., or display units using cathode ray tubes.

A touch panel may be used also as independent information input means, but, in the present circumstances, it is usually used in the form where it is laminated on the display surface of a display unit.

In a display unit used together with a liquid crystal panel, an image produced on the liquid crystal panel is irradiated with illumination light. After transmitted or reflected, the illumination light is emitted from the liquid crystal panel toward the display surface. Thus, the image is made visible. On the other hand, an organic EL panel applies an electric field to a thin film of an organic electroluminescence material so that display is performed by the control of a current. A plasma panel excites a fluorescent substance with ultraviolet rays generated by plasma discharge so as to carry out display.

Generally, liquid crystal display units are typically used as panel-type display units in the present circumferences. In a liquid crystal display unit, a liquid crystal panel is used as follows. That is, in the liquid crystal panel, a liquid crystal layer is retained in a gap with which a pair of substrates having pixel selection electrodes and so on are panel-aligned with each other. Then, the alignment state of liquid crystal molecules in the portion of selected pixels is changed to produce an image. The produced image is not visible as it is. Therefore, the liquid crystal panel is irradiated with light given from the outside. Thus, the image is observed through the transmitted or reflected light of the external light.

There are various types of touch panels in view of their principles of operation. Of them, a so-called analog resistance film type in which input coordinates are detected by the resistance change quantity is the most popular.

In such an analog resistance film type touch panel, one substrate on the information input side is formed of a transparent soft film such as a plastic sheet, and the other substrate is formed of a transparent hard substrate which is preferably made of glass or transparent hard plastic. Resistance films are provided on the opposed surfaces of the pair of transparent substrates respectively. Two-dimensional coordinate values are detected by resistance values between an output terminal and the respective resistance films of the substrates brought into contact with each other by depressing operation on the information-input-side substrate.

As described above, usually in the touch panel configured thus, information is inputted by use of an input operation tool like a pen point. The resistance films formed on the inner surfaces of the pair of substrates respectively have to be always insulated electrically from each other. Therefore, spacers are interposed between the pair of substrates so as to ensure a gap to an extent that the resistance films of the substrates can be brought into contact with each other by the pen-point-like depression of the operation tool.

However, if the gap between the pair of substrates is too large, the sunk quantity of the soft film which is an information-input-side substrate (upper substrate) by the depression by the operation tool is so large as to produce a feeling of incompatibility with ordinary writing. Thus, there is a case where a sense of comfortable input cannot be obtained.

Further, when an input operation is performed at an input region end, the bending deformation quantity of the soft film becomes large. Though occurring rare, the resistance film (upper resistance film) formed on the inner surface of the soft film or the soft film itself may be cracked because of the repetition of the input operation.

Incidentally, examples of references of the general related art of such a screen input type liquid crystal display unit include JP-A-60-207924 and JP-A-3-156818. On the other hand, examples in connection with a gap between a pair of substrates include JP-A-8-94995, JP-A-10-69354, JP-A-8-101740, JP-U-62-81141, etc.

Further, examples of documents disclosing the related art about methods for manufacturing touch panels include JP-A-6-324784 and JP-A-6-324785.

In a conventional touch panel which constitutes a screen input type display unit configured thus, an upper resistance film and a lower resistance film are formed over input regions of respective inner surfaces of a pair of substrates (that is, an upper substrate which is generally a flexible film, and a lower substrate which is generally a hard plate of glass or the like). An upper wiring electrode and a lower wiring electrode connected to the respective resistance films are formed in the outer circumferences of the input regions of the pair of substrates respectively.

A lower wiring electrode leading wire extending from the lower wiring electrode, an inter-substrate connection electrode electrically connected to the upper wiring electrode, and an upper wiring electrode leading wire extending from the inter-substrate connection electrode are formed in parts of the outer circumference of the input region of the lower substrate. The end portions of the lower wiring electrode leading wire and the upper wiring electrode leading wire are collected at one place and extended to a leader line connection region provided in a part of the outer circumferential end portion of the input region.

In this leader line connection region, an output printed board having leader lines for extracting output signals from the upper wiring electrode leading wire and the lower wiring electrode leading wire is attached by means such as thermo-compression bonding or the like. That is, in the touch panel of this type, all the terminals of the printed board are provided on the lower substrate side.

Conventionally, such an output printed board is attached in the following manner. That is, the output printed board is held between the upper and lower substrates in the leader line connection region. Alternatively, as shown in JP-A-3-156818, the lower substrate is extended to be longer than the upper substrate, and the upper wiring electrode leading wire and the lower wiring electrode leading wire are formed in the extension portion of the lower substrate to extend from the upper wiring electrode and the inter-substrate connection electrode. Then, the output printed board is attached by thermo-compression bonding.

In the method in which the output printed board is held between the upper and lower substrates, the upper substrate may swell out in the leader line connection region. Accordingly, processing is required to prevent the distortion of display or an input error caused by such swelling.

On the other hand, in the method disclosed in JP-A-3-156818, the size of the touch panel increases by the extension portion of the lower substrate. This is one of factors to hinder the realization of a narrow frame of the touch panel (and the display unit using the touchpanel). Accordingly, it is a problem to be solved.

To manufacture such a touch panel, the upper substrate is cut off into a predetermined size and a predetermined shape, and thereafter subjected to panel alignment with the lower substrate. After that, the lower substrate is cut into a unit panel. In such a manufacturing method, the upper substrate has to be positioned accurately to be subjected to panel alignment with the lower substrate. Thus, the working efficiency cannot be regarded as excellent.

There is another problem that foreign matters produced particularly in cutting a hard plate contaminate the touch panel.

Further, the upper and lower wiring electrode leading wires are extracted from the upper and lower wiring electrodes laid in the region which is covered with the upper substrate, respectively. Then, the upper and lower wiring electrode output terminals are collected in the leader line connection region, and bent toward the leader line connection region. As a result, there is apt to appear a gap in the vicinity of the portion where the upper and lower wiring electrode output terminals are connected with the output printed board. Foreign matters are apt to enter between the upper and lower substrates through such a gap. Thus, the properties of the resistance films may change due to the entrance of the foreign matters. This is one of factors to cause a malfunction of the touch panel, and hence it is also a problem to be solved.

Incidentally, in each of the touch panels disclosed in JP-A-6-324784 and JP-A-6-324785, both the upper and lower substrates are soft substrates. In the two applications, no suggestion is made about the existence of the above-mentioned respective problems in a structure where a soft upper substrate is subjected to panel alignment with a hard lower substrate. The present invention is aimed at such a structure.

It is a first object of the present invention to provide a method for manufacturing a touch panel which is superior in manufacturing efficiency and which can prevent contamination with foreign matters at the time of cutting. Thus, the touch panel can be manufactured at low cost.

It is a second object of the present invention to provide a touch panel which has no malfunction, which has a narrow frame, and which is reduced in size, weight and thickness.

It is a third object of the present invention to provide a high-reliability screen input type display unit using a touch panel which has no malfunction, which has a narrow frame, and which is reduced in size, weight and thickness.

### SUMMARY OF THE INVENTION

To attain the first object, a method for manufacturing a touch panel according to the present invention has the following features.

(1) A method for manufacturing a touch panel, comprising the steps of: adhering an upper substrate and a lower substrate to each other, the upper substrate being made of a soft film member with an upper resistance film, the lower substrate being made of a hard plate with a lower resistance film; and subsequently cutting off the upper substrate and the lower substrate.

(2) In the above paragraph (1), the lower substrate is made of a glass plate or a plastic plate.

(3) In the aboveparagraph (1) or (2), the lower substrate is cut off after the upper substrate is cut off.

(4) In the above paragraph (3), after the upper substrate is cut off by a first blade, the first blade is replaced by a second blade for cutting off the lower substrate, and then the lower substrate is cut off.

(5) In the above paragraph (1) or (2), the upper substrate and the lower substrate are cut off simultaneously.

(6) In any one of the above paragraphs (1) to (5), the lower substrate is cut of f from the side of the upper substrate.

(7) In any one of the above paragraphs (1) to (5), the lower substrate is cut off from a side opposite to the upper substrate.

(8) In any one of the above paragraphs (1) to (7), a first base material which will be cut off to obtain a plurality of the upper substrates and a second base material which will be cut off to obtain a plurality of the lower substrates are adhered to each other, and subsequently the first base material and the second base material are cut off.

(9) In any one of the above paragraphs (1) to (8), the touch panel has the upper substrate, the lower substrate and an output printed board for extracting output signals; the lower substrate has lower wiring electrode leading wires and upper wiring electrode leading wires, the lower wiring electrode leading wires being electrically connected to the lower resistance film and extending to a leader line connection region of an outer circumferential end portion of an input region, the upper wiring electrode leading wires being electrically connected to the upper resistance film and extending to the leader line connection region; the lower wiring electrode leading wires and the upper wiring electrode leading wires are connected to the output printed board in the leader line connection region; and at least a portion of the upper substrate corresponding to the leader line connection region is removed.

(10) In the above paragraph (9), before the upper substrate and the lower substrate are adhered to each other, at least the portion of the upper substrate corresponding to the leader line connection region is removed.

(11) In the above paragraph (9), after the upper substrate and the lower substrate are adhered to each other, at least the portion of the upper substrate corresponding to the leader line connection region is removed.

(12) In the above paragraph (9), before the upper substrate and the lower substrate are cut off, the upper substrate and the lower substrate are connected to the output printed board.

(13) In the above paragraph (9), after the upper substrate and the lower substrate are cut off, the upper substrate and the lower substrate are connected to the output printed board.

(14) In anyone of the above paragraphs (9) to (13), spacers 2 to 20 μm high are formed on the lower resistance film of the lower substrate by a printing method.

According to the above-mentioned manufacturing method stated in any one of the paragraphs (1) to (14), the following effects can be obtained. That is, the upper and lower substrates are cut off after being subjected to adhered to each other. Thus, foreign matters can be prevented from entering between the upper and lower substrates particularly when a hard plate is cut off. Particularly, glass dust produced when the lower substrate of a glass plate is cut off can be prevented from entering between the upper and lower substrates. In addition, in the case of gain printing, a printing step and a cleaning step for resistance films, electrodes, adhesive materials can be carried out in a lump. As a result, the working efficiency is improved.

The upper and lower substrates can be cut off simultaneously without turning over the substrates panel-aligned with each other, for example, by use of a laser beam or by use of cutting blades provided for the upper and lower substrates separately. If the lower substrate is cut off from the upper substrate side, the pair of substrates can be cut off likewise without turning over them.

When the lower substrate is cut off from the side opposite to the upper substrate, the blade for cutting off the lower substrate is not affected by the upper substrate. Thus, the lower substrate can be cut off in the same position as or closely to the position where the upper substrate is cut off.

Moreover, to attain the foregoing second invention, a touch panel according to the present invention has the following features.

(15) A touch panel comprising: an upper substrate having an upper resistance film; a lower substrate having a lower resistance film; and an output printed board for extracting output signals; wherein the lower substrate has lower wiring electrode leading wires and upper wiring electrode leading wires, the lower wiring electrode leading wires being electrically connected to the lower resistance film and extending to a leader line connection region of an outer circumferential end portion of an input region, the upper wiring electrode leading wires being electrically connected to the upper resistance film and extending to the leader line connection region; wherein the lower wiring electrode leading wires and the upper wiring electrode leading wires are connected to the output printed board in the leader line connection region; and wherein a portion of the upper substrate corresponding to the leader line connection region is removed to follow a shape of an installation portion of the output printed board.

(16) A touch panel comprising: an upper substrate having an upper resistance film; a lower substrate having a lower resistance film; and an output printed board for extracting output signals; wherein the lower substrate has lower wiring electrode leading wires and upper wiring electrode leading wires, the lower wiring electrode leading wires being electrically connected to the lower resistance film and extending to a leader line connection region of an outer circumferential end portion of an input region, the upper wiring electrode leading wires being electrically connected to the upper resistance film and extending to the leader line connection region; wherein the lower wiring electrode leading wires and the upper wiring electrode leading wires are connected to the output printed board in the leader line connection region; wherein a part or all of the lower wiring electrode leading wires and the upper wiring electrode leading wires are laid to be drawn into a side surface of the output printed board along a side of the lower substrate where the leader line connection region exists; and wherein a side of the upper substrate where at least a portion corresponding to the leader line connection region exists is wholly removed.

According to the aforementioned configuration, it is possible to provide a touch panel which has no malfunction, which has a narrow frame, and which is reduced in size, weight and thickness.

Further, to attain the foregoing third object, a screen input type display unit according to the present invention has the following features.

(17) A screen input type display unit in which a touch panel is installed on a display surface of the display unit, wherein: the touch panel has an upper substrate having an upper resistance film, a lower substrate having a lower resistance film, and an output printed board for extracting output signals; the lower substrate has lower wiring electrode leading wires and upper wiring electrode leading wires, the lower wiring electrode leading wires being electrically connected to the lower resistance film and extending to a leader line connection region of an outer circumferential end portion of an input region, the upper wiring electrode leading wires being electrically connected to the upper resistance film and extending to the leader line connection region; the lower wiring electrode leading wires and the upper wiring electrode leading wires are connected to the output printed board in the leader line connection region; and a portion of the upper substrate corresponding to the leader line connection region is removed to follow a shape of an installation portion of the output printed board.

(18) In the touch panel stated in the above paragraph (17), at least a part of the lower wiring electrode leading wires and the upper wiring electrode leading wires of the lower substrate are laid to be drawn into a side surface of the output printed board along a side of the lower substrate where the leader line connection region exists.

(19) In the touch panel stated in the above paragraph (17) or (18), an end surface of the upper substrate is located correspondingly to an end surface of the lower substrate.

(20) In any one of the above paragraphs (17) to (19), the upper substrate and the lower substrate are opposed to each other through spacers 2 to 20 μm high.

(21) A screen input type display unit in which a touch panel is installed on a display surface of the display unit, wherein: the touch panel has an upper substrate having an upper resistance film, a lower substrate having a lower resistance film, and an output printed board for extracting output signals; the lower substrate has lower wiring electrode leading wires and upper wiring electrode leading wires, the lower wiring electrode leading wires being electrically connected to the lower resistance film and extending to a leader line connection region of an outer circumferential end portion of an input region, the upper wiring electrode leading wires being electrically connected to the upper resistance film and extending to the leader line connection region; the lower wiring electrode leading wires and the upper wiring electrode leading wires are connected to the output printed board in the leader line connection region; a part or all of the lower wiring electrode leading wires and the upper wiring electrode leading wires are laid to be drawn into a side surface of the output printed board along a side of the lower substrate where the leader line connection region exists; and a side of the upper substrate where at least a portion corresponding to the leader line connection region exists is wholly removed.

(22) In the above paragraph (21), the upper substrate and the lower substrate are opposed to each other through spacers 2 to 20 μm high.

According to the aforementioned configuration, it is possible to provide a high-reliability screen input type display unit using a touch panel which has no malfunction, which has a narrow frame, and which is reduced in size, weight and thickness.

Incidentally, when a liquid crystal display unit is used as a display unit in the present invention, a liquid crystal panel thereof may be a so-called passive matrix type one, a so-called active-matrix type one, or any other known one. In addition, such a liquid crystal panel may be combined with a reflection type one, a transmission type one or a semi-transmission/reflection type one.

Further, an organic EL panel, a plasma panel or a cathode ray tube may be used as a display unit, as described previously.

In addition, the present invention is not limited to the above-mentioned configurations or configurations of embodiments that will be described later. The present invention is likewise applicable to a touch panel of a so-called digital type in which depressed coordinates are detected by a change in capacity between upper and lower substrates or a change in another quantity of electricity. Various modifications can be made without departing from the technical idea of the present invention.

The manufacturing method in which the substrates are cut off after being adhered to each other can be also applied to a touch panel of such a type that the inter-substrate connection electrode is not provided in the lower substrate, but an upper wiring electrode leading wire is formed on the upper substrate so that each of the upper and lower substrates makes a connection to the outside without making an electric connection with each other.

### BRIEF DESCRIPTION OF THE DRAWINGS

FIG. 1 is a typical sectional view for explaining an example of a screen input type display unit which has a touch panel according to the present invention;

FIG. 2 is a developed perspective view for explaining the schematic configuration of a first embodiment of a touch panel provided in a screen input type display unit according to the present invention;

FIG. 3 is a main portion plan view for typically explaining an example of the structure of a leader line connection region of the touch panel explained in FIG. 2, in which a lower substrate is viewed from an upper substrate side;

FIG. 4 is a sectional view taken on line A-A in FIG. 3;

FIG. 5 is a sectional view taken on line B-B in FIG. 3;

FIG. 6 is a typical plan view for explaining the frame narrowing effect of the touch panel provided in the screen input type display unit according to the present invention;

FIG. 7 is an explanatory view of the schematic configuration of a second embodiment of a touch panel provided in a screen input type display unit according to the present invention, (a) being a perspective view, (b) being a side view;

FIG. 8 is an explanatory view of the schematic configuration of a third embodiment of a touch panel provided in a screen input type display unit according to the present invention;

FIG. 9 is an explanatory view of the schematic configuration of a fourth embodiment of a touch panel provided in a screen input type display unit according to the present invention, (a) being a sectionally side view, (b) being an enlarged view of the portion D in the side view (a) of FIG. 9;

FIG. 10 is an explanatory view of the schematic configuration of a fifth embodiment of a touch panel provided in a screen input type display unit according to the present invention;

FIG. 11 is a sectional view taken on line a-a in FIG. 10;

FIG. 12 is a sectional view taken on line b-b in FIG. 10;

FIG. 13 is a sectional view taken on line c-c in FIG. 10;

FIG. 14 is a main portion sectional view for explaining a defect appearing when there is a large distance between upper and lower substrates;

FIG. 15 is a schematically sectional view for explaining the main portion configuration of a sixth embodiment of a touch panel provided in a screen input type display unit according to the present invention;

FIG. 16 is a schematically sectional view for explaining the main portion configuration of a seventh embodiment of a touch panel provided in a screen input type display unit according to the present invention;

FIG. 17 is a flow chart showing the total flow of a method for manufacturing a touch panel for use in a screen input type display unit according to the present invention;

FIG. 18 is an explanatory view of a first embodiment of a method for manufacturing a touch panel for use in a screen input type display unit according to the present invention;

FIG. 19 is an explanatory view of a second embodiment of a method for manufacturing a touch panel for use in a screen input type display unit according to the present invention;

FIG. 20 is an explanatory view following FIG. 19 and showing the second embodiment of the method for manufacturing a touch panel for use in the screen input type display unit according to the present invention;

FIG. 21 is an explanatory view of a third embodiment of a method for manufacturing a touch panel for use in a screen input type display unit according to the present invention;

FIG. 22 is an explanatory view following FIG. 21 and showing the third embodiment of the method for manufacturing a touch panel for use in the screen input type display unit according to the present invention;

FIG. 23 is an explanatory view of a fourth embodiment of a method for manufacturing a touch panel for use in a screen input type display unit according to the present invention;

FIG. 24 is an explanatory view following FIG. 23 and showing the fourth embodiment of the method for manufacturing a touch panel for use in the screen input type display unit according to the present invention;

FIG. 25 is an explanatory view of a fifth embodiment of a method for manufacturing a touch panel for use in a screen input type display unit according to the present invention;

FIG. 26 is an explanatory view following FIG. 25 and showing the fifth embodiment of the method for manufacturing a touch panel for use in the screen input type display unit according to the present invention;

FIG. 27 is an explanatory view of a sixth embodiment of a method for manufacturing a touch panel for use in a screen input type display unit according to the present invention;

FIG. 28 is an explanatory view following FIG. 27 and showing the sixth embodiment of the method for manufacturing a touch panel for use in the screen input type display unit according to the present invention;

FIG. 29 is an explanatory view of a seventh embodiment of a method for manufacturing a touch panel for use in a screen input type display unit according to the present invention;

FIG. 30 is an explanatory view following FIG. 29 and showing the seventh embodiment of the method for manufacturing a touch panel for use in the screen input type display unit according to the present invention;

FIG. 31 is a sectional view for explaining a first mode for carrying out a screen input type display unit according to the present invention;

FIG. 32 is a sectional view for explaining another mode for carrying out a screen input type display unit according to the present invention;

FIG. 33 shows five views (a)-(e) for explaining the external appearance of the screen input type display unit according to the present invention;

FIGS. 34A to 34D are main portion sectional views sectioned on lines A-A, B-B, C-C, and D-D in FIG. 33; and

FIG. 35 is an explanatory view of an example of an information processing apparatus using the screen input type display unit according to the present invention.

### DESCRIPTION OF THE PREFERRED EMBODIMENT

The mode for carrying out the present invention will be described below in detail with reference to an embodiment using an analog system for detecting a change in resistance by way of example.

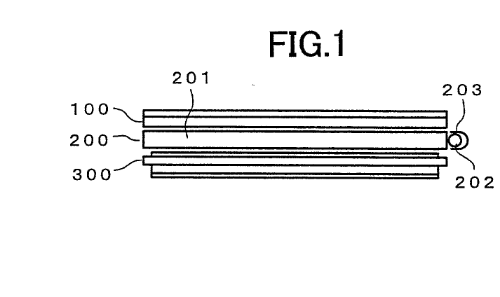

FIG. 1 is a typical sectional view for explaining an example of a screen input type display unit provided with a touch panel according to the present invention. In FIG. 1, the screen input type display unit is constituted by a touch panel 100 according to the present invention, a illuminator 200 and a liquid crystal display unit 300 which is an example of a display unit. The illuminator 200 has a light guide plate 201, a light source lamp 202 and a reflector 203. The illuminator 200 is mounted on the display surface of the liquid crystal display unit 300, and the touch panel 100 is laminated on the illuminator 200.

The illuminator 200 is usually called a front light for the liquid crystal display unit 300. Such a screen input type display unit is often installed in an apparatus commercialized as a portable information terminal. However, there is another type in which a illuminator is mounted on the back surface of a liquid crystal display unit. In such a case, the illuminator is called a back light. Incidentally, some small-size or low-price screen input type display units using liquid crystal display units exclude the illuminators.

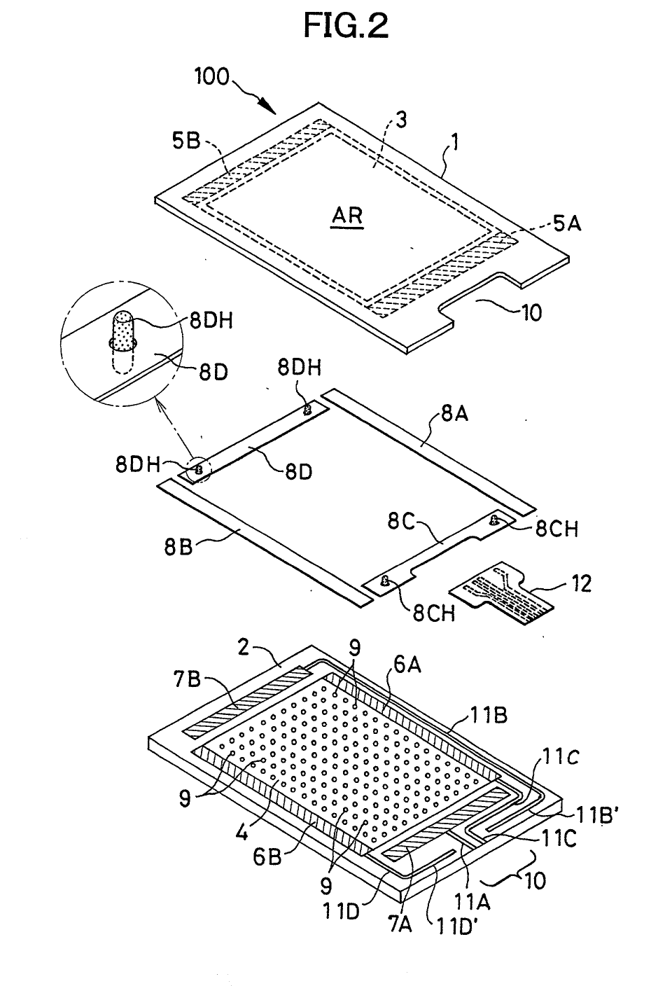

FIG. 2 is a developed perspective view for explaining the schematic configuration of a first embodiment of a touch panel provided in the screen input type display unit according to the present invention. The touch panel in this embodiment has a film-like upper substrate 1 and a lower substrate 2 made of a glass plate. The upper substrate 1 has an upper resistance film 3 formed in its inner surface, and the lower substrate 2 has a lower resistance film 4 formed in its inner surface likewise. The upper and lower substrates 1 and 2 are panel-aligned with each other through adhesive materials 8A to 8D.

The upper and lower resistance films 3 and 4 are preferably transparent metal thin films of ITO or the like, but other conductive transparent thin films may be used. In this embodiment, ITO is used. In addition, conductive paste such as silver paste or the like is applied to the opposite ends of the respective resistance films by means of printing or the like, so as to form upper and lower wiring electrodes 5A, 5B and 6A, 6B therein. In this embodiment, silver paste is used.

In addition, a portion corresponding to a leader line connection region 10 is removed from a side of the outer circumference of an input region (viewing area) AR of the upper substrate 1. In this portion, an output printed board 12 is disposed. The output printed board 12 has leader lines connected to upper wiring electrode leading wires 11A and 11B, and lower wiring electrode leading wires 11C and 11D for extracting output signals. The shape with which the portion corresponding to the leader line connection region 10 is removed from the upper substrate 1 follows the outer shape of a connection portion of the output printed board 12 substantially.

Dot-like spacers 9 are formed on the lower resistance film 4 formed in the lower substrate 2, so as to prevent the upper and lower resistance films 3 and 4 from contacting with each other at a normal time. The spacers 9 can be formed by a so-called photolithographic technique. That is, photosensitive resin is applied so as to be exposed through a photo-mask having predetermined apertures so that the exposed portion of the photosensitive resin is solidified. In consideration of prevention of feeling of incompatibility in input operation, the distance between the upper and lower substrates is about 20 μm at maximum.

On the other hand, though depending on the size of the pointed end of an input operation tool such as a pen point or the like, if a general pen-point-like tool having a radius of 0.8 mm is used, the spacers 9 may be at least about 2 μm high in the case where a PET film 0.188 μm thick is used for the upper substrate 1. It is also preferable that a distance between adjacent ones of the spacers 9 is set to be about 1.5 mm. Thus, it is preferable that the height of the spacers 9 is set to be in a range of from 2 μm to 20 μm. The spacers 9 are not limited to dot-like shapes, but may have any shapes such as bank-like shapes, strip-like shapes, or the like, if these shapes are not obstacles to input operation.

Then, the upper and lower substrates 2 and 3 are subjected to panel alignment with each other at their circumferential edges through the adhesive materials 8A to 8D. In this embodiment, a double-faced adhesive tape is used for the adhesive materials 8A to 8D. However, an adhesive agent or a pressure-sensitive adhesive agent may be applied in place of the double-faced adhesive tape.

As shown in FIG. 2, the upper wiring electrodes 5A and 5B are provided in the left/right-direction and on the opposite end portions of the upper resistance film 3 formed on the inner surface of the upper substrate 1. The lower wiring electrodes 6A and 6B are provided in the up/down-direction and on the opposite end portions of the lower resistance film 4 formed in the inner surface of the lower substrate 2.

The upper wiring electrodes 5A and 5B are electrically connected to inter-substrate connection electrodes 7A and 7B formed on the lower substrate 2, respectively. This connection is performed through conductive paste 8CH, 8DH (herein, silver paste) provided to penetrate the adhesive materials 8C and 8D partially.

The upper wiring electrode leading wire 11A drawn out from the inter-substrate connection electrode 7A and the upper wiring electrode leading wire 11B drawn out from the inter-substrate connection electrode 7B are drawn out to the connection region 10 of the output printed board 12.

The upper wiring electrode leading wires 11C and 11D drawn out from the lower wiring electrodes 6A and 6B connected to the lower resistance film 4 respectively are also drawn out to the connection region 10 of the output printed board 12.

Thus, the upper resistance film 3, the upper wiring electrodes 5A and 5B, the conductive pastes 8CH and 8DH, the inter-substrate connection electrodes 7A and 7B, and the upper wiring electrode leading wires 11A and 11B are electrically connected to one another.

In the same manner, the lower resistance film 4, the lower wiring electrodes 6A and 6B, and the lower wiring electrode leading wires 11C and 11D are electrically connected to one another.

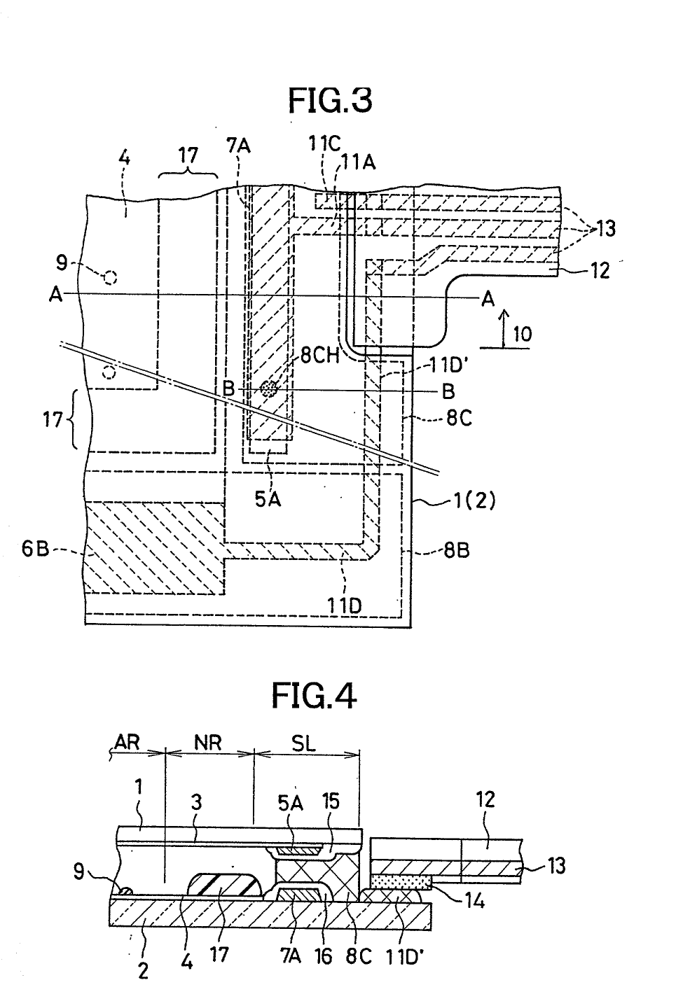

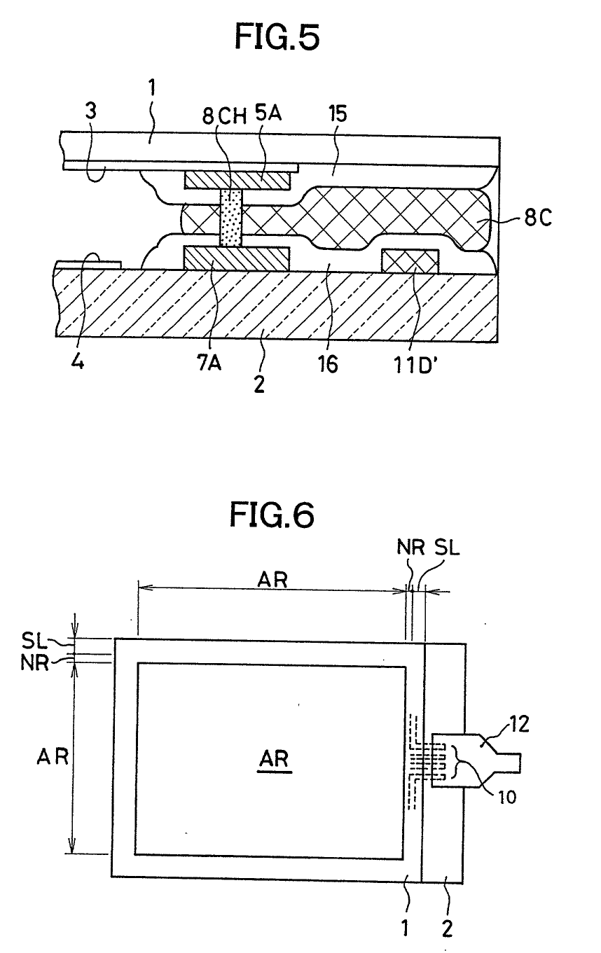

FIG. 3 is a main portion plan view for typically explaining an example of the structure of the leader line connection region of the touch panel explained in FIG. 2, in which the lower substrate is viewed from the upper substrate side. In addition, FIG. 4 is a sectional view taken on line A-A in FIG. 3, and FIG. 5 is a sectional view taken on line B-B in FIG. 3. In FIGS. 3 to 5, parts having the same functions as those in FIG. 2 are referenced correspondingly (the same thing is applied to the drawings which will be described below).

The output printed board 12 is provided in the leader line connection region 10 of the lower one 2 of the upper and lower substrates 1 and 2 panel-aligned with each other. Wires 13 are formed in an interposed layer in the output printed board 12. The open end portions of the wires 13 are exposed to the lower substrate 2 and connected to end portions of wiring electrode leading wires 11 through a conductive bonding material 14.

The upper and lower wiring electrode leading wires 11A to 11D are drawn out to the connection region 10 of the lower substrate 2 with the output printed board 12. Wiring electrode leading wires 11B′ and 11D′ of the upper and lower wiring electrode leading wires 11B and 11D are laid in parallel with the side where the leader wire connection region 10 exists. Then, the wiring electrode leading wires 11B′ and 11D′ are drawn into the output printed board 12 from its side surface.

As shown in FIG. 4, in the outer circumference of the input region AR, an adhesive material 8C is located in a seal portion SL separated from the input region AR by an inactive region NR. The upper wiring electrode 5A and the inter-substrate connection electrode 7A are coated with insulating layers 15 and 16 in the seal portion SL. The insulating layers 15 and 16 are not essential, but they had better be provided to prevent deterioration such as oxidation of the upper wiring electrode 5A and the inter-substrate connection electrode 7A in a humid environment of use, or the like.

Incidentally, the inactive region NR shown in FIG. 4 is established in consideration of a portion incapable of input operation due to the gap between the upper and lower substrates. In the inactive region NR, a stress reliever 17 is formed for avoiding damage to the upper resistance film 3 or the upper substrate 1, as will be described later. The stress reliever 17 is formed into a dot-like or bank-like shape out of a material similar to that of the spacers 9.

FIG. 5 explains an example of a structure in which the upper wiring electrode 5A (5B) formed in the inner surface of the upper substrate 1 is electrically connected with the inter-substrate connection electrode 7A (7B) formed in the inner surface of the lower substrate 2. The upper wiring electrode 5A (5B) and the inter-substrate connection electrode 7A (7B) are connected through the conductive paste 8CH (8DH) charged to penetrate the adhesive material 8C (8D). The conductive paste 8CH (8DH) is preferably a silver paste.

According to the configuration in this embodiment, it is not necessary to take into consideration an input failure caused by the fact that the output printed board 12 is held between the upper and lower substrates so that the upper substrate protuberates. It is therefore possible to use a thick printed board. In addition, some of the wiring electrode leading wires are drawn into the printed board from its side surface along the side where the leader line connection region 10 exists. Thus, it is possible to narrow the frame.

In addition, the portion of the upper substrate 1 corresponding to the leader line connection region 10 is cut out. Accordingly, the work to insert the output printed board 12 between the upper and lower substrates 1 and 2 is omitted. It is therefore possible to improve the manufacturing efficiency.

FIG. 6 is a typical plan view for explaining the frame narrowing effect of the touch panel provided in the screen input type display unit according to the present invention. As shown in FIG. 6, the wiring electrode leading wires in the leader line connection region 10 of the conventional touch panel are drawn out in front of the front end of the output printed board 12.

Thus, a space to ensure the leader line connection region 10 is required in the lower substrate 2 so that there is a limit in narrowing the frame.

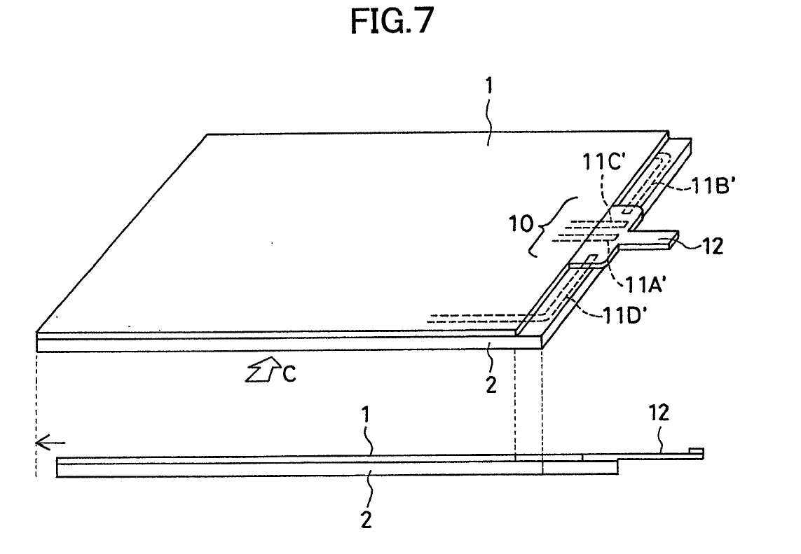

FIG. 7 is an explanatory view of the schematic configuration of a second embodiment of a touch panel provided in a screen input type display unit according to the present invention. (a) of FIG. 7 is a perspective view, and (b) of FIG. 7 is a side view in which (a) of FIG. 7 is viewed from the direction of the arrow C. In the touch panel in this embodiment, an upper substrate is removed from the whole side including a leader line connection region 10. In addition, front end portions 11B′ and 11D′ of wiring electrode leading wires 11B and 11D in the leader line connection region 10 are laid in parallel with the side where the leader line connection region 10 exists. Thus, the front end portions 11B′ and 11D′ are drawn into an output printed board 12 from its side surfaces respectively.

Incidentally, front end portions 11A′, 11B′, 11C′ and 11D′ of all the wiring electrode leading wires 11A to 11D may be laid in parallel with the side where the leader line connection region 10 exists. In this case, all the front end portions 11A′ to 11D′ are drawn into the output printed board 12 from its side surfaces respectively.

According to this embodiment, it is not necessary to take into consideration an input failure caused by the fact that the output printed board 12 is held between the upper and lower substrates 1 and 2 at the leader line connection region 10 so that the upper substrate 1 protuberates. It is therefore possible to use a thick output printed board. In addition, some or all of front end portions of wiring electrode leading wires are drawn about in parallel with the side where the leader line connection region exists. Thus, it is possible to narrow the frame in the same manner as in the first embodiment.

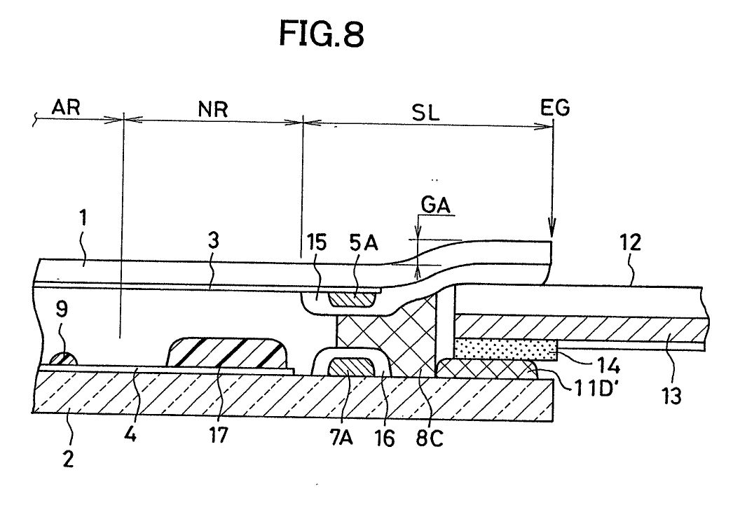

FIG. 8 is an explanatory view of the schematic configuration of a third embodiment of a touch panel provided in a screen input type display unit according to the present invention. The removal of the upper substrate 1 as described in the second embodiment of the present invention described in FIG. 7 is not carried out in this embodiment.

In the same manner as in FIG. 7, apart of a wiring electrode leading wire 11D′ of a wiring electrode output terminal 11D is laid in parallel with the side where the leader line connection region 10 exists. Then, the wiring electrode leading wire 11D′ is drawn into the output printed board 12 from its side surface. Thus, wiring electrode leading wires picked out to the output printed board between the upper and lower substrates are prevented from concentration in one place. As a result, in comparison with the case where all the wiring electrode leading wires 11A to 11D are collected and drawn out on the front side of the output printed board 12 as shown in FIG. 6, a protuberance quantity GA of the upper substrate 1 is reduced. Thus, moisture or the like can be prevented from entering from the leader line connection region 10, and the frame can be narrowed.

In addition, if the thickness of the output printed board 12 is reduced, the protuberance quantity GA of the upper substrate 1 is further reduced.

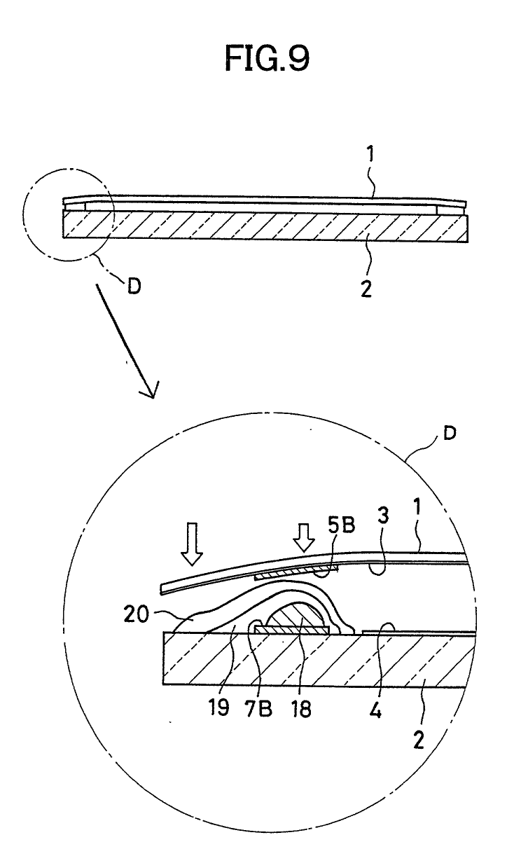

FIG. 9 is an explanatory view of the schematic configuration of a fourth embodiment of a touch panel provided in a screen input type display unit according to the present invention. (a) of FIG. 9 shows a sectional view of the touch panel as a whole, and (b) of FIG. 9 shows an enlarged view of a portion D in (a) of FIG. 9. This embodiment provides means for preventing the surface evenness of an upper substrate 1 from changing due to a change in the environment of use.

In this embodiment, the section of a seal portion where the upper substrate 1 is adhered to a lower substrate 2 is slightly inclined outward from the input region side. In (b) of FIG. 9, the side opposite to the leader line connection region 10 in FIG. 2 is shown by way of example.

In this seal portion, silver paste 18 is applied onto an inter-substrate connection electrode 7B of the lower substrate 2 so as to swell out. An insulating material 19 is applied on the silver paste 18 so as to be thicker in the outside of the silver paste 18 than that in the center thereof. An adhesive material 20 is further applied onto the insulating material 19.

The upper substrate 1 is depressed onto the insulating material 19 in the arrow direction so as to be adhered thereto. Thus, tension is applied to the upper substrate 1 so that the input region keeps parallel with the lower substrate 2.

Incidentally, the structure of the seal portion is not limited to the illustrated one. Any other suitable structure may be used to apply tension to the upper substrate 1. For example, a plurality of lines or dots of the silver paste 18, the insulating material 19 or the adhesive material 20 may be applied or marked so that their height is reduced gradually as goes toward the outside. Such an adhesive structure may be applied to other sides.

According to this embodiment, the surface evenness of the upper substrate 1 can be always kept so that a feeling of incompatibility in input operation due to the slackness of the upper substrate 1 can be prevented from generating.

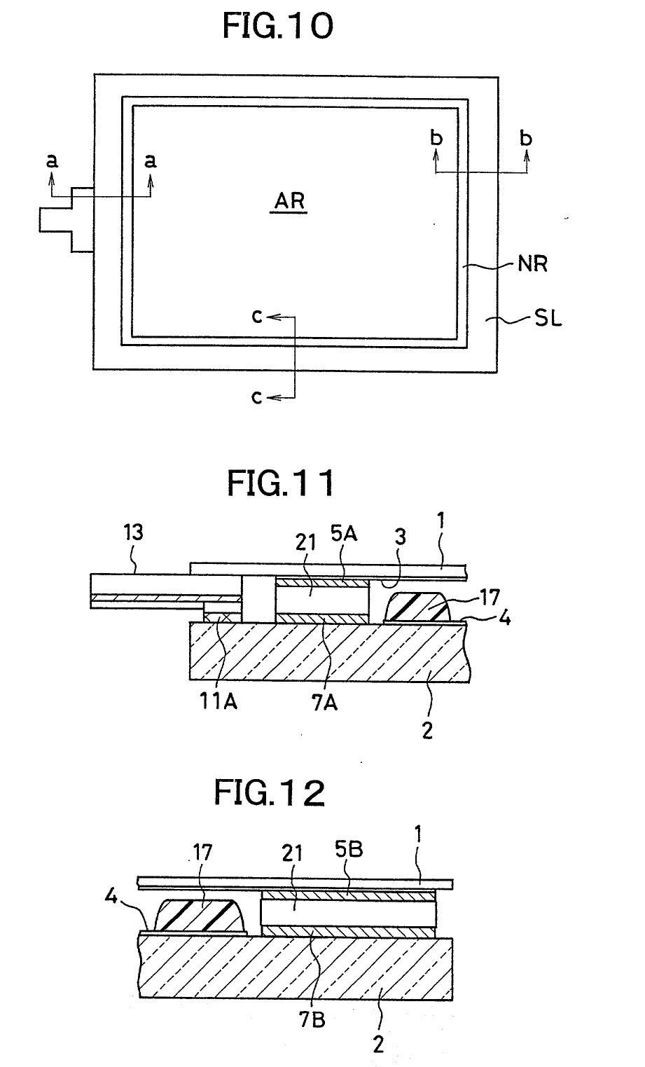

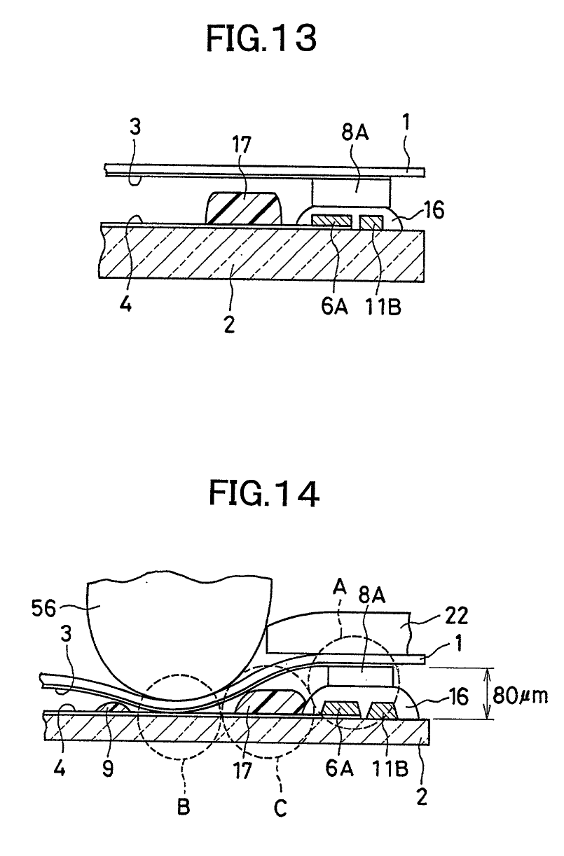

FIG. 10 is an explanatory view of the schematic configuration of a fifth embodiment of a touch panel provided in a screen input type display unit according to the present invention. FIG. 10 shows a plan view for explaining an inactive region in the outermost side of an input region of the touch panel. FIG. 11 is a sectional view taken on line a-a in FIG. 10; FIG. 12, a sectional view taken on line b-b in FIG. 10; and FIG. 13, a sectional view taken on line c-c in FIG. 10. In FIGS. 10 to 13, parts having the same functions as those in the drawings of the above-mentioned embodiment are referenced correspondingly.

In the touch panel shown in FIG. 10, there is a seal portion SL all over the outermost circumference of an input region of the touch panel, and an inactive region NR is provided between the seal portion SL and the input region AR, as shown in FIG. 13.

In this inactive region NR, a stress reliever 17 for preventing an upper substrate 1 from bending sharply is provided by printing or the like. Incidentally, in this embodiment, upper wiring electrodes 5A and 5B are adhesively connected with inter-substrate connection electrodes 7A and 7B through a conductive and double-faced adhesive tape 21 respectively.

However, even if such a stress reliever 17 is provided, a large distance between the upper and lower substrates may result in such a failure that an upper resistance film formed in the inner surface of the upper substrate is cracked or the upper substrate itself is damaged.

FIG. 14 is a main portion sectional view for explaining a defect occurring when there is a large distance between the upper and lower substrates. FIG. 14 corresponds to FIG. 13 described previously. The lower wiring electrode 6A, the upper wiring electrode leading wire 11B, the insulating material 16 and the stress reliever 17 are provided in the periphery of the lower substrate 2. The upper substrate 1 is adhesively fixed to the lower substrate 2 through the adhesive material 8A.

When an input operation is carried out by pressing the upper substrate 1 with the pointed end of a pen point 56 so as to bring the upper resistance film 3 into contact with the lower resistance film 4, the upper substrate 1 is bent toward the lower substrate 2 in the portion where the upper substrate 1 is fixed thereto through the adhesive material 8A.

The upper substrate 1 is subjected to bending in the end portion of the adhesive material 8A in a portion A, the contact portion (corner portion) with the stress reliever 17 in a portion C, and the contact portion with the lower resistance film 4 in a portion B. In such portions subjected to bending, the upper resistance film 3 is cracked, or the upper substrate itself is damaged easily. Particularly, such a crack or damage is apt to appear in the end portion of the adhesive material 8A in the portion A. Incidentally, the reference numeral 22 represents an apparatus cover.

To prevent such a crack or damage, it can be considered to widen the extent of the stress reliever 17. However, if there is a large distance between the upper and lower substrates, the extent of the stress reliever 17 becomes so large that the frame becomes wide.

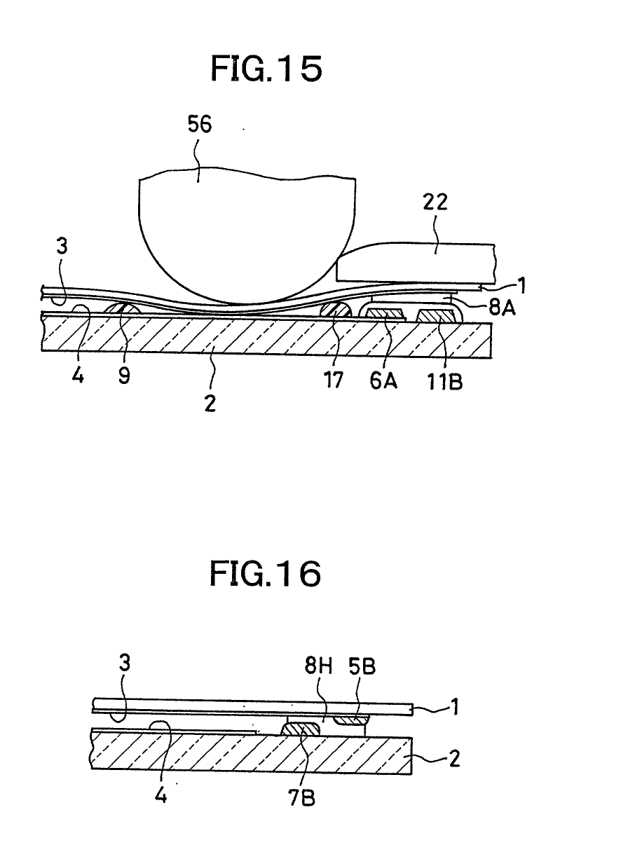

FIG. 15 is a schematically sectional view for explaining the main portion configuration of a sixth embodiment of a touch panel provided in a screen input type display unit according to the present invention, which is similar to FIG. 14. In this embodiment, respective layers formed on the inner surface of the lower substrate 2 by printing or the like, such as the lower wiring electrode 6A (6B), the upper wiring electrode leading wire 11B, and soon, are reduced in thickness so that the distance between the upper and lower substrates is reduced. It is preferable that each of the layers is about 5 to 20 μm thick.

As a result, the bending quantity of the upper substrate is reduced. Thus, the extent of the stress reliever is reduced so that the input region can be increased. That is, the frame can be narrowed.

FIG. 16 is a schematically sectional view for explaining the main portion configuration of a seventh embodiment of a touch panel provided in a screen input type display unit according to the present invention. In this embodiment, an upper wiring electrode 5B (5A) formed in the inner surface of an upper substrate 1 and an inter-substrate connection electrode 7B (7A) formed in the inner surface of a lower substrate 2 are formed in positions offset to each other in the upper and lower substrates.

FIG. 16 shows the case where the upper wiring electrode 5B (5A) and the inter-substrate connection electrode 7B (7A) are offset. A conductive adhesive material 8H is located between the upper wiring electrode 5B (5A) and the inter-substrate connection electrode 7B (7A) so as to fix them. In a portion of any other side where there is a resistance film or an electrode which needs no electric connection between the upper and lower substrates, an insulating adhesive material is located between the upper and lower substrates so as to fix them.

According to this configuration, the distance between the upper and lower substrates 1 and 2 can be reduced even if various electrodes formed in the upper and lower substrates are set to be as thick as that in the related art. In addition, in such a configuration, not only is it possible to omit the installation of a stress reliever, but it is also possible to narrow the frame.

According to the above-mentioned embodiment, it is possible to obtain a touch panel which has no input malfunction and which can be reduced in size and thickness.

Next, description will be made about a method for manufacturing a touch panel for use in a screen input type display unit according to the present invention.

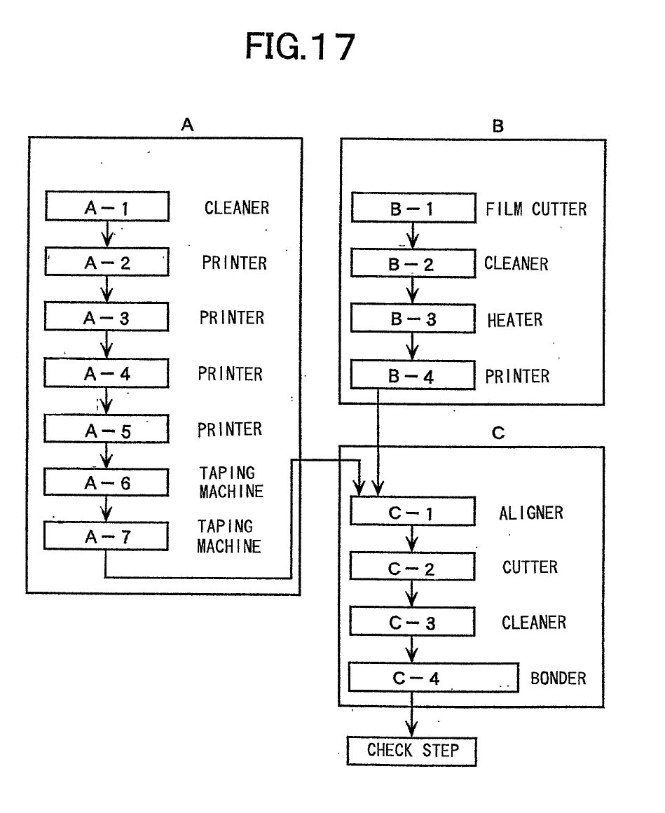

FIG. 17 is a flow chart for explaining an example of a method for manufacturing a touch panel for use in a screen input type display unit according to the present invention. FIG. 17 is constituted by a step group A on the left hand for explaining the steps of processing a lower substrate, a step group B on the upper right hand for explaining the steps of processing an upper substrate, and a step group C on the lower right hand for explaining the steps of assembling the upper and lower substrates. These steps show the case where the upper and lower substrates are adhered to each other through a double-faced adhesive tape, and a conductive double-faced adhesive tape is used for electric connection between an upper wiring electrode and an inter-substrate connection electrode.

In the step group A, a received lower-resistance-film-including glass substrate (mother glass) is cleaned by a cleaner (A-1), and thereafter spacers (herein, dot spacers) are printed by a printer (A-2). Silver (Ag) paste is printed on opposite ends of the upper resistance film formed in the inner surface of the glass substrate (A-3). Thus, lower wiring electrodes, inter-substrate connection electrodes, and leading wires are formed.

After that, an insulating material is printed on a predetermined portion (A-4), and a stress reliever which is a member for forming an inactive region described previously is printed around an input region (A-5) (inactive region printing=stress relief member printing).

Then, a conductive double-faced adhesive tape is stuck on upper/lower conduction portions by use of a taping machine (A-6) (for an upper and lower substrates conducting process), while an adhesive tape is stuck on another portions (A-7) (for an upper and lower substrates adhering process) so as to obtain a lower substrate. Alternatively, a method in which an adhesive agent is applied in place of the double-faced adhesive tape may be adopted.

In the step group B, a received upper-resistance-film-including film is cut into a predetermined size (mother film size) by a film cutter (B-1), cleaned (B-2), and annealed (B-3). After that, silver paste is printed (B-4) so as to form upper wiring electrodes. Thus, an upper substrate is obtained. Incidentally, when a conductive adhesive member (e.g. conductive double-faced adhesive tape, or the like) is adhered directly to the upper substrate, this silver paste printing step may be omitted.

In the step group C, the finished upper and lower substrates are subjected to panel alignment by a panel aligner (C-1) so as to be adhered to each other with a predetermined gap. After being adhered, the panel-aligned substrates are cut into a product size by a cutter (C-2), and cleaned by a cleaner (C-3). Lastly, a flexible printed board (FPC) which will be a signal output terminal (output printed board, or, so-called tail) is bonded to the substrates (C-4). Thus, a touch panel is completed. The completed touch panel is delivered to a check step so as to be checked in accordance with predetermined check items.

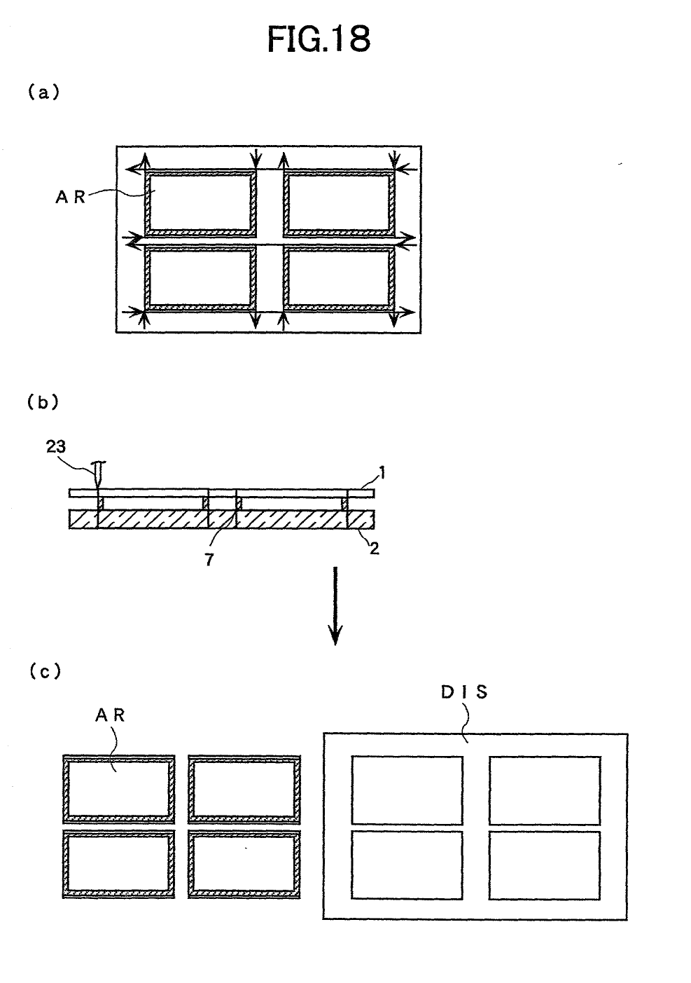

FIG. 18 is an explanatory view of a first embodiment of a method for manufacturing a touch panel for use in a screen input type display unit according to the present invention. In this embodiment, an upper substrate 1 in which an upper resistance film and upper wiring electrodes are formed in the inner surface of a PET film, and a lower substrate 2 in which a lower resistance film, lower wiring electrodes, and upper and lower wiring electrode leading wires are formed in the inner surface of a glass plate, are adhesively fixed by use of a double-faced adhesive tape as an adhesive material.

In (a) of FIG. 18, four unit touch panels can be obtained from a laminate of a sheet of PET film base material (mother film) and a sheet of glass base material (mother glass) panel-aligned with each other.

After the four unit touch panels are panel-aligned as shown in (a) of FIG. 18, the upper substrate is cut by use of a cutter 23 having an exclusive blade. The arrows in (a) of FIG. 18 show an operating track of the cutter for exclusive use in cutting the upper substrate. Incidentally, (b) of FIG. 18 shows a side view of (a) of FIG. 18. Next, the back surface of the lower substrate is scribed with the same track as the aforementioned cutting line of the upper substrate. Then, as shown in (c) of FIG. 18, the laminate is broken to obtain four unit touch panels each having an input region AR, as products. The other portion becomes a disused portion DIS. The cutter may be replaced by another cutting means such as a laser beam or the like.

In addition, the cutting lines for the upper and lower substrates need not have the same track, but they may be located closely to each other.

Thus, by cutting the upper and lower substrates after they are adhered to each other, it is possible to avoid the problem of contamination with foreign matters produced particularly when a hard plate is cut off. In addition, the upper and lower substrates can be made corresponding to each other or accurately close to each other in panel alignment position and cut position. Further, the working efficiency of panel alignment is also improved. Particularly, the effect is high in gain printing.

Incidentally, although the description is made about the case where one laminate is made into four pieces, not to say, more gain printing can be carried out within the size allowed by the mother film or the mother glass.

In addition, the manufacturing method in which cutting is carried out after panel alignment is not limited to a touch panel which is designed to have a conduction structure between upper and lower substrates and to have leading wires formed on only one of the substrates. Accordingly, the manufacturing method can be also applied to a touch panel in which no inter-substrate connection electrode or the like is provided, and upper wiring electrode leading wires formed in an upper substrate and lower wiring electrode leading wires formed in a lower substrate are connected to the outside respectively.

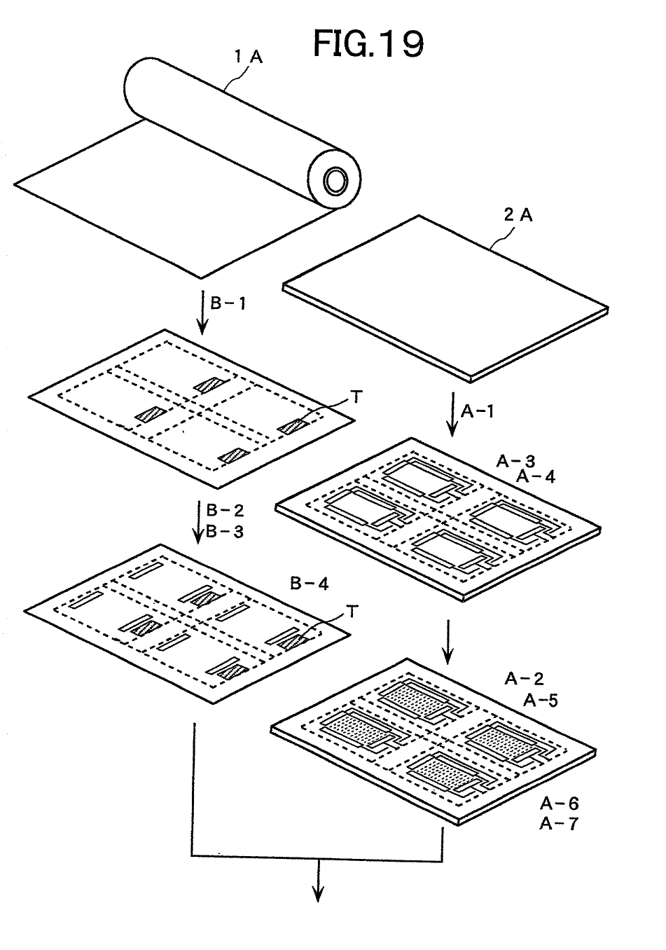

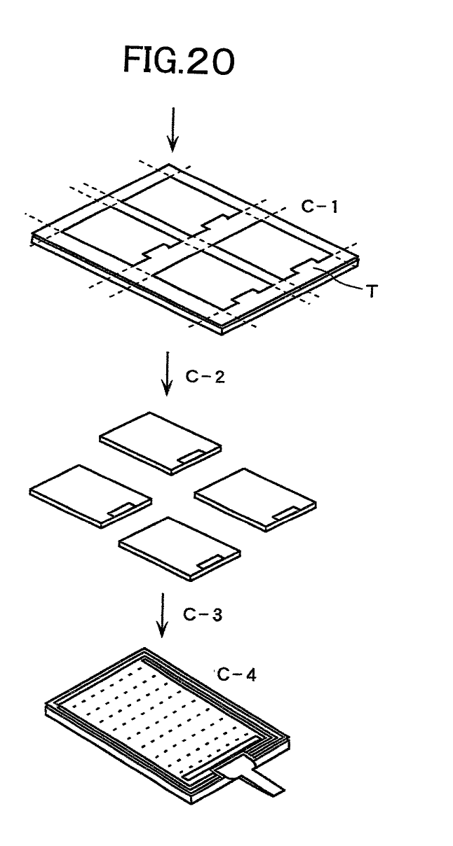

FIGS. 19 and 20 are explanatory views of a second embodiment of a method for manufacturing a touch panel for use in a screen input type display unit according to the present invention. In FIGS. 19 and 20, steps A-1 to A-7, B-1 to B-4, and C-1 to C-4 correspond to the steps A-1 to A-7, B-1 to B-4, and C-1 to C-4 in FIG. 17.

In this embodiment, an upper-resistance-film-including upper substrate raw material 1A, which has been received in the form of a roll, is cut into a predetermined size (B-1). A leader line connection region (hereinafter, also referred to as “tail portion”) T to which an output printed board will be bonded is removed, and the upper substrate raw material 1A is cleaned (B-2) and annealed (B-3).

After that, silver (Ag) paste to form wiring electrodes is printed (B-4). Thus, a base material of an upper substrate (mother film) is obtained.

On the other hand, a glass substrate 2A to be a lower substrate is received and cleaned (A-1). Silver (Ag) paste to form wiring electrodes is printed (A-3, A-4). Then, dot spacers are printed (A-2), and a stress relief member is printed (A-5). Next,a conductive adhesive tape is stuck on upper/lower conduction portions (A-6) (for an upper and lower substrates conducting process) while an adhesive tape is stuck on another portions (A-7) (for an upper and lower substrates adhering process) so as to obtain a lower substrate (mother glass size).

The upper and lower substrates are positioned as they are a mother film and a mother glass, and they are panel-aligned with each other by bonding with a predetermined depression (C-1). The panel-paneled substrates are cut into a unit panel size (C-2), and cleaned (C-3). Lastly, an output printed board (tail) is bonded to the leader line connection region so as to complete a touch panel (C-4).

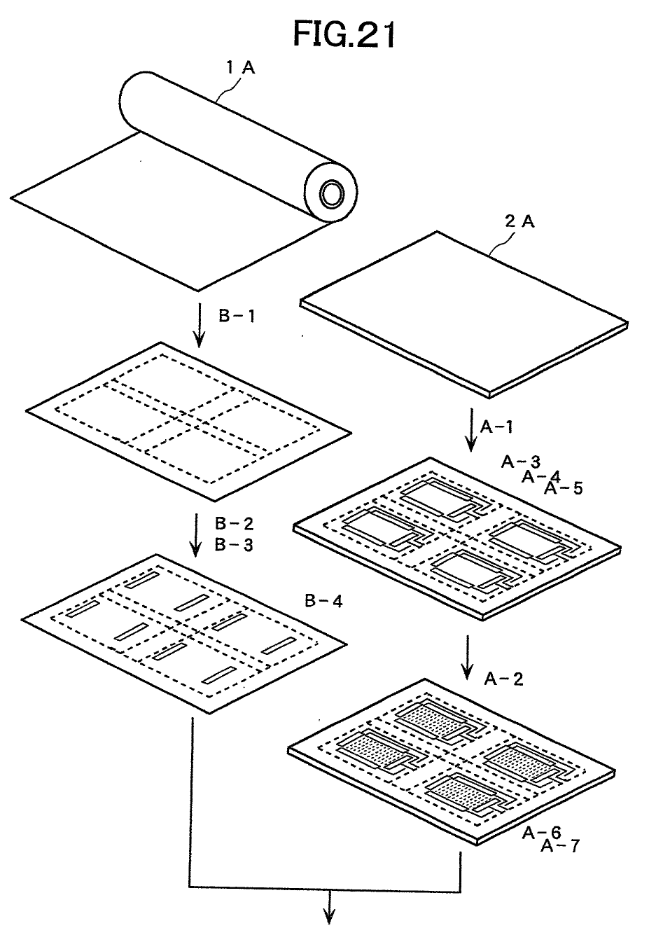

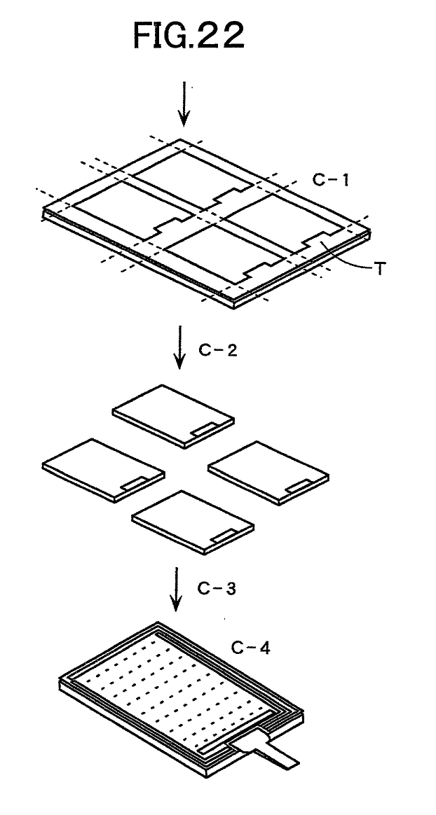

FIGS. 21 and 22 are explanatory views of a third embodiment of a method for manufacturing a touch panel for use in a screen input type display unit according to the present invention. In FIGS. 21 and 22, steps A-1 to A-7, B-1 to B-4, and C-1 to C-4 correspond to the steps A-1 to A-7, B-1 to B-4, and C-1 to C-4 in FIG. 17.

In this embodiment, an upper-resistance-film-including upper substrate raw material 1A, which has been received in the form of a roll, is cut into a predetermined size (B-1), cleaned (B-2), and annealed (B-3). After that, silver (Ag) paste to form wiring electrodes is printed (B-4). Thus, a base material of an upper substrate (mother film) is obtained.

On the other hand, a glass substrate 2A to be a lower substrate is received and cleaned (A-1). Silver (Ag) paste to form wiring electrodes is printed (A-3), and an insulating layer is printed (A-4). Then, a stress relief member is printed (A-5). After that, dot spacers are printed(A-2), and a conductive adhesive tape is stuck on upper/lower conduction portions (A-6) while an adhesive tape is stuck on another portions (A-7) so as to obtain a lower substrate (mother glass size).

The upper and lower substrates are positioned as they are a mother film and a mother glass, and they are panel-aligned with each other by bonding with a predetermined depression (C-1). A leader line connection region (tail portion) T, to which an output printed board will be bonded, is removed, cut into a unit panel size (C-2), and cleaned (C-3). Lastly, an output printed board (tail) is bonded to the leader line connection region so as to complete a touch panel (C-4).

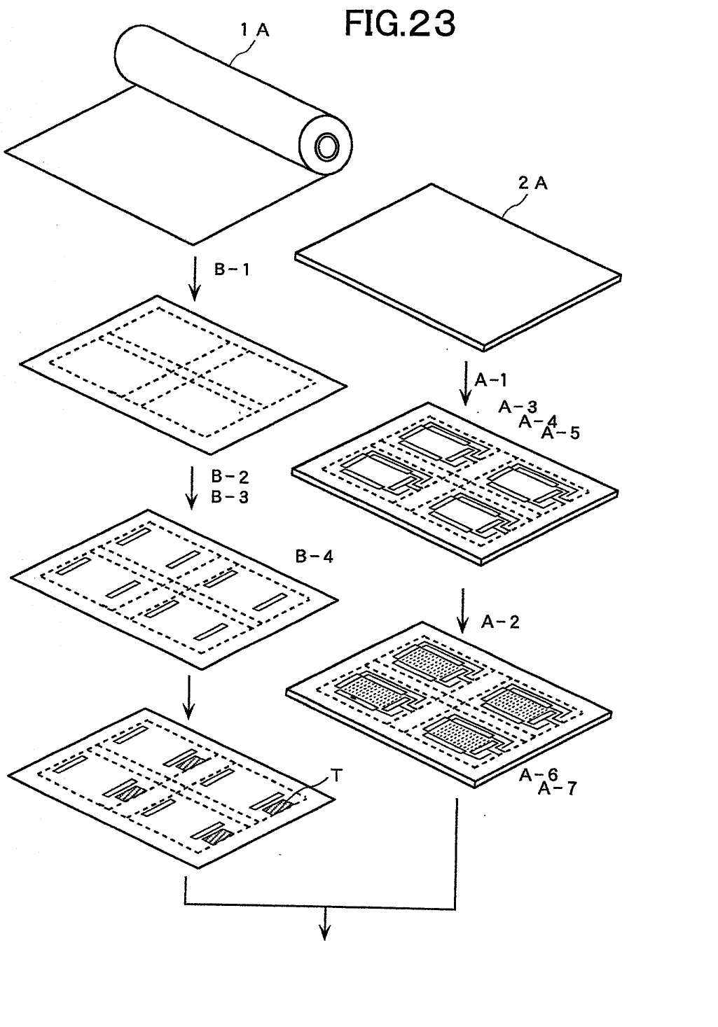

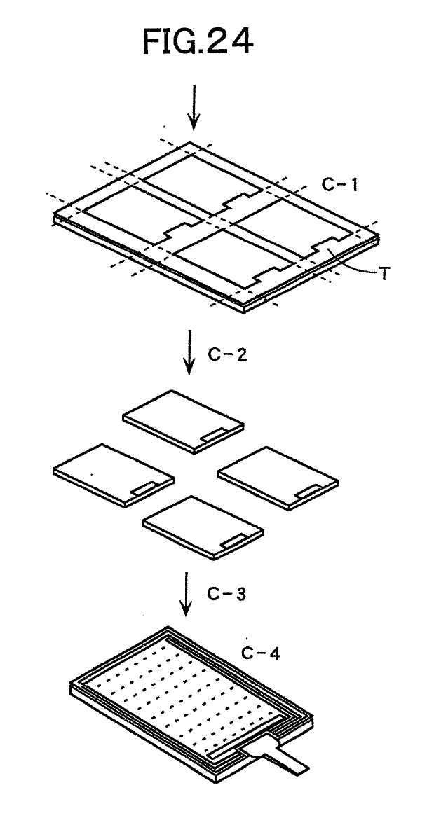

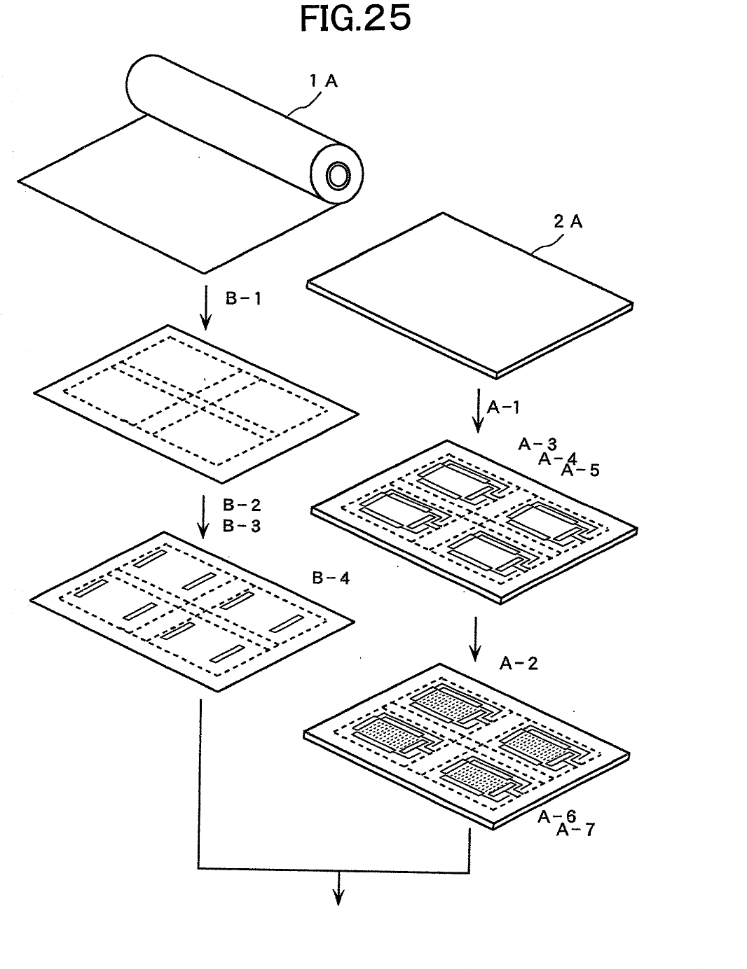

FIGS. 23 and 24 are explanatory views of a fourth embodiment of a method for manufacturing a touch panel for use in a screen input type display unit according to the present invention. In FIGS. 23 and 24, steps A-1 to A-7, B-1 to B-4, and C-1 to C-4 correspond to the steps A-1 to A-7, B-1 to B-4, and C-1 to C-4 in FIG. 17.

In this embodiment, an upper-resistance-film-including upper substrate raw material 1A, which has been received in the form of a roll, is cut into a predetermined size (B-1), cleaned (B-2) and annealed (B-3).

After that, silver (Ag) paste to form wiring electrodes is printed (B-4), and a tail portion is removed. Thus, a base material of an upper substrate (mother film) is obtained.

On the other hand, a glass substrate 2A to be a lower substrate is received and cleaned (A-1). Silver (Ag) paste to form wiring electrodes is printed (A-3), and an insulating layer is printed (A-4). Then, dot spacers are printed(A-2), a stress relief member is printed (A-5). Next, a conductive adhesive tape is stuck on upper/lower conduction portions (A-6) (for an upper and lower substrates conducting process) while an adhesive tape is stuck on another portions (A-7) (for an upper and lower substrates adhering process) so as to obtain a lower substrate (mother glass size).

The upper and lower substrates are positioned as they are a mother film and a mother glass, and they are panel-aligned with each other by bonding with a predetermined depression (C-1). The upper substrate is cut into a unit panel size, and the lower substrate is cut, along the cutting line of the upper substrate, into the unit panel size (C-2). Then, the panel-aligned substrates are cleaned (C-3). Lastly, an output printed board (tail) is bonded to the leader line connection region so as to complete a touch panel (C-4).

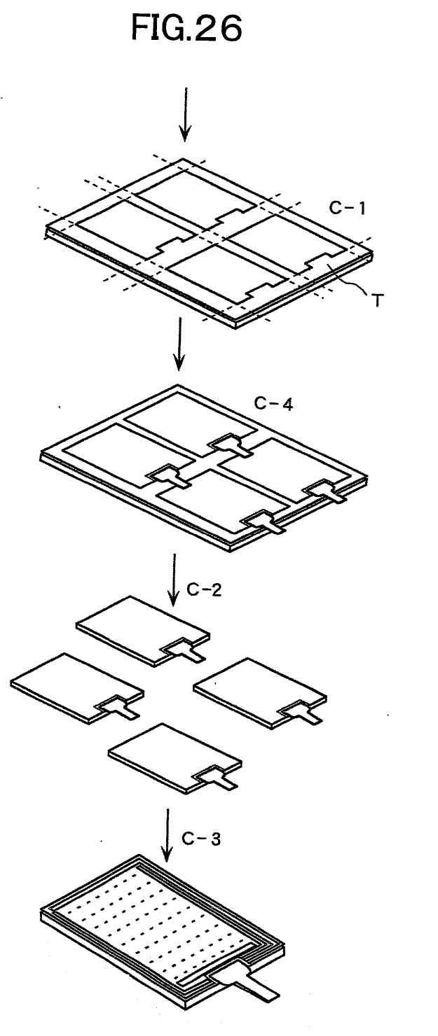

FIGS. 25 and 26 are explanatory views of a fifth embodiment of a method for manufacturing a touch panel for use in a screen input type display unit according to the present invention. In FIGS. 25 and 26, steps A-1 to A-7, B-1 to B-4, and C-1 to C-4 correspond to the steps A-1 to A-7, B-1 to B-4, and C-1 to C-4 in FIG. 17.

In this embodiment, an upper-resistance-film-including upper substrate raw material 1A, which has been received in the form of a roll, is cut into a predetermined size (B-1), cleaned (B-2), and annealed (B-3).

After that, silver (Ag) paste to form wiring electrodes is printed (B-4). Thus, a base material of an upper substrate (mother film) is obtained.

On the other hand, a glass substrate 2A to be a lower substrate is received and cleaned (A-1). Silver (Ag) paste to form wiring electrodes is printed (A-3), and an insulating layer is printed (A-4). Then, a stress relief member is printed (A-5). Next,dot spacers are printed(A-2), a conductive adhesive tape is stuck on upper/lower conduction portions (A-6) (for an upper and lower substrates conducting process) while an adhesive tape is stuck on another portions (A-7) (for an upper and lower substrates adhering process) so as to obtain a lower substrate (mother glass size).

The upper and lower substrates are positioned as they are a mother film and a mother glass, and they are panel-aligned with each other by bonding with a predetermined depression. Then, the upper substrate is cut into a unit panel size while a leader line connection region is removed as an unnecessary portion (C-1). An output printed board (tail) is bonded to the leader line connection region (C-4), and cut into the unit panel size (C-2). Then, the panel-aligned substrates are cleaned (C-3) so as to complete a touch panel.

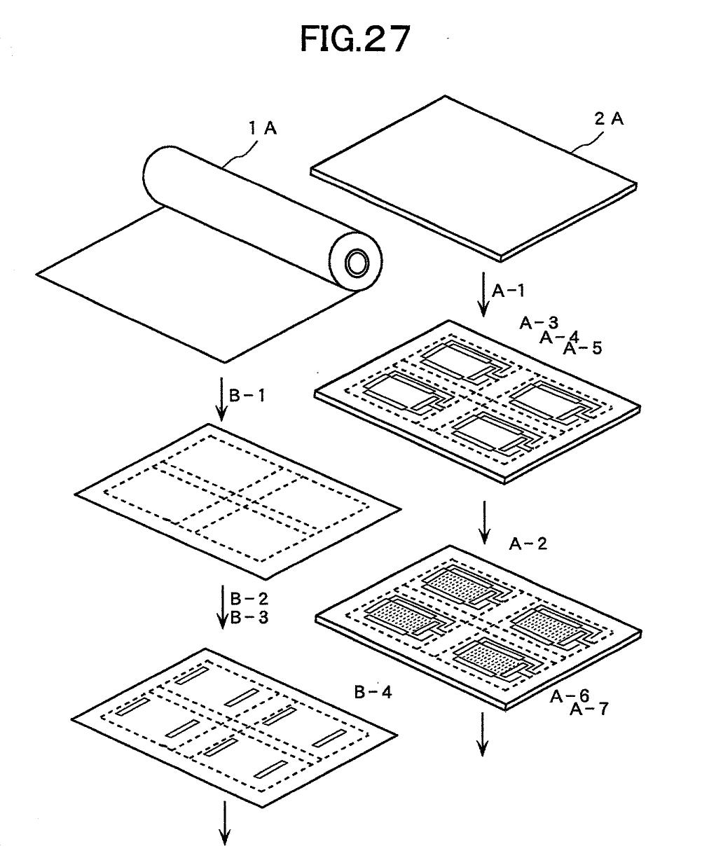

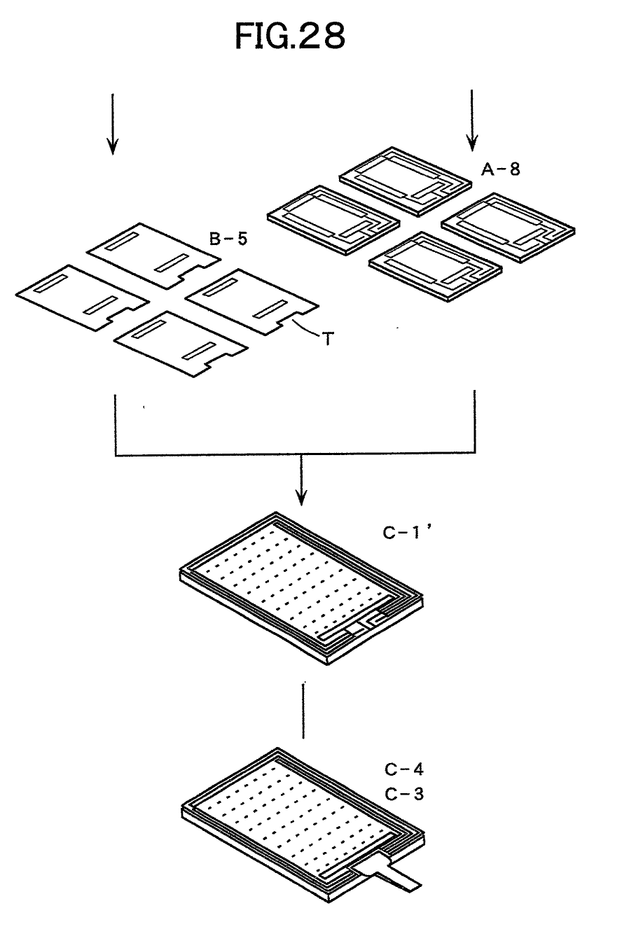

FIGS. 27 and 28 are explanatory views of a sixth embodiment of a method for manufacturing a touch panel for use in a screen input type display unit according to the present invention. In FIGS. 27 and 28, steps A-1 to A-7, B-1 to B-4, and C-1 to C-4 correspond to the steps A-1 to A-7, B-1 to B-4, and C-1 to C-4 in FIG. 17.

In this embodiment, an upper-resistance-film-including upper substrate raw material 1A, which has been received in the form of a roll, is cut into a predetermined size (B-1), cleaned (B-2), and annealed (B-3). After that, silver (Ag) paste to form wiring electrodes is printed (B-4), and cut into individual touch panel sizes (B-5). At the same time, a leader line connection region (tail portion) to which an output printed board will be bonded is removed from each of the touch panels.

On the other hand, a glass substrate 2A to be a lower substrate is received and cleaned (A-1). Silver (Ag) paste to form wiring electrodes is printed (A-3), and an insulating layer is printed (A-4). Then, a stress relief member is printed (A-5),and dot spacers are printed. Next,a conductive adhesive tape is stuck on upper/lower conduction portions (A-6) while an adhesive tape is stuck on another portions (A-7). Then cut into individual touch panel sizes(A-8).

The upper and lower substrates cut into individual sizes are positioned and panel-aligned with each other (C-1′). Then, an output printed board (tail) is bonded to the leader line connection region (C-4), and cleaned (C-3). Thus, a touch panel is completed.

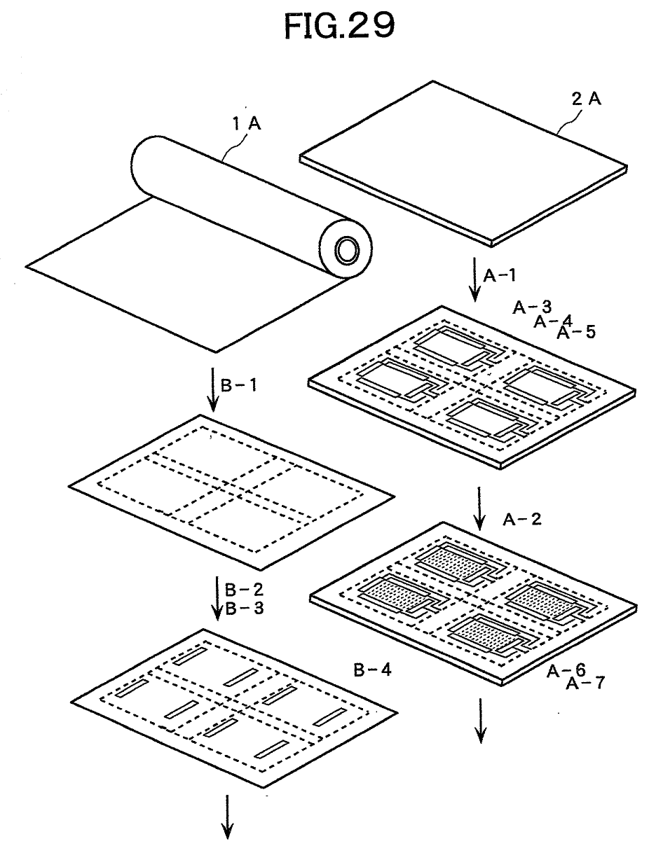

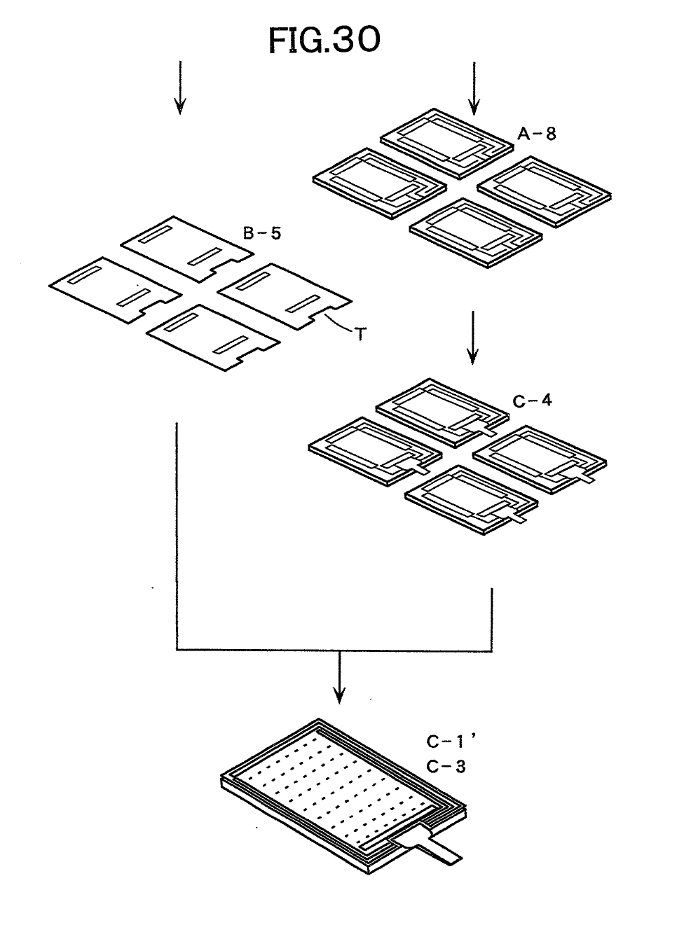

FIGS. 29 and 30 are explanatory views of a seventh embodiment of a method for manufacturing a touch panel for use in a screen input type display unit according to the present invention. In FIGS. 29 and 30, steps A-1 to A-7, B-1 to B-4, and C-1 to C-4 correspond to the steps A-1 to A-7, B-1 to B-4, and C-1 to C-4 in FIG. 17.

In this embodiment, an upper-resistance-film-including upper substrate raw material 1A, which has been received in the form of a roll, is cut (B-1), cleaned (B-2), and annealed (B-3). After that, silver (Ag) paste to form wiring electrodes is printed (B-4), and cut into individual touch panel sizes (B-5). At the same time, a leader line connection region (tail portion) to which an output printed board will be bonded is removed from each of the touch panels.

On the other hand, a glass substrate 2A to be a lower substrate is received and cleaned (A-1). Silver (Ag) paste to form wiring electrodes is printed (A-3), and an insulating layer is printed(A-4). Then, a stress relief member is printed (A-5),and dot spacers are printed(A-2). Next, a conductive adhesive tape is stuck on upper/lower conduction portions (A-6) while an adhesive tape is stuck on another portions (A-7).And cut into individual touch panel sizes(A-8).

An output printed board (tail) is bonded to the leader line connection region of the cut-off lower substrate (C-4).

The upper and lower substrates cut into individual sizes are positioned and panel-aligned with each other (C-1′), and cleaned (C-3). Thus, a touch panel is completed.

Touch panels completed according to the respective steps of the respective manufacturing methods described above are delivered to a check step so as to be checked for predetermined check items.

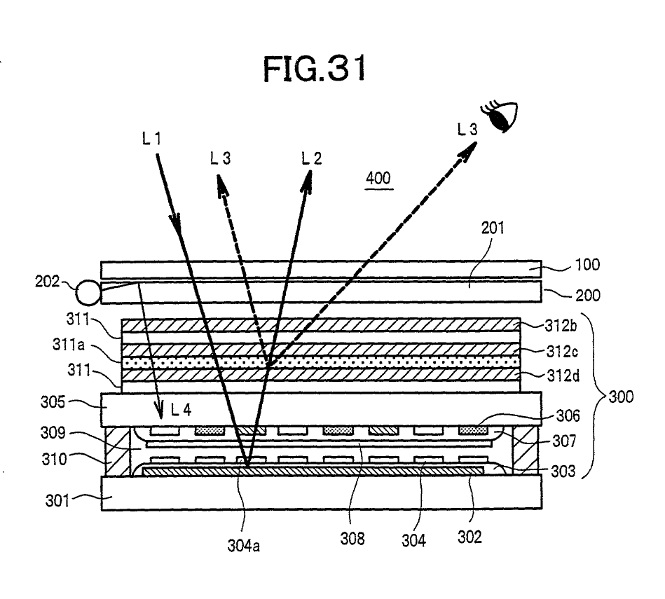

An embodiment of the whole configuration of a screen input type display unit according to the present invention in which a touch panel manufactured thus has been incorporated will be described in detail with reference to FIGS. 31, 32, 33, 34A to 34D, and 35.

FIG. 31 is a sectional view for explaining a first mode for carrying out a screen input type display unit according to the present invention. In this mode, a back light (illuminator) 200 constituted by a light guide plate 201 and a linear lamp 202, and a touch panel 100 according to any one of the embodiments described previously, are installed in a reflection type liquid crystal panel 300.

A reflection layer 302, a protective layer 303, and lower electrodes (signal electrodes) 304 are formed in the inner surface of a first substrate 301 which is a lower substrate of the liquid crystal panel 300. The reflection layer 302 is made of an aluminum thin film. The protective layer 303 is made of an anti-reflection film of SiO2 or the like. Each of the lower electrodes is made of a transparent conductive film of ITO or the like.

On the other hand, a color filter 306 of three colors (R, G, and B), a protective film 307, and an upper electrode (scanning electrode) 308 are formed in the inner surface of a second substrate 305 which is an upper glass substrate. In the color filter 306, dyes or pigments are added to an organic resin film so as to form the three colors (R, G and B). The protective layer 307 is made of an organic material for preventing impurities from contaminating a liquid crystal layer 309 from the color filter 306, and for flattening the inner surface of the second substrate 305. The upper electrode 308 is made of a transparent conductive film of ITO or the like.

Incidentally, a lattice-shaped or stripe-shaped light shielding film (black matrix) is formed among the respective colors R, G and B forming the color filter 306 in accordance with necessity. The protective film 307 is formed on the light shielding film.

A liquid crystal layer 309 made of a liquid crystal composition is injected between the first and second substrates 301 and 305, and sealed off with a seal material 310 of epoxy resin or the like. Thus, a liquid crystal display panel is arranged.

A polarizing plate 312b, a first phase-difference plate 312c and a second phase-difference plate 312d are laminated on the surface of the second substrate 305 of the liquid crystal panel. Adhesive layers 311 and 311a of an adhesive agent (e.g. epoxy or acrylic adhesive agent), an adhesive material, or the like, are provided among the polarizing plate 312b, the first phase-difference plate 312c and the second phase-difference plate 312d. Thus, the respective members 311, 311a, 312b, 312c and 312d are fixed.

Incidentally, here, the adhesive agent means an adhesive agent by which, even if various kinds of optical films 312b to 312d once stuck on each other are peeled off, the optical films 312b to 312d can be stuck on each other again. When various kinds of optical films 312b to 312d or the liquid crystal panel is fixed by use of such an adhesive agent, even if the optical films 312b to 312d or the liquid crystal panel is fixed by mistake, the optical films 312b to 312d or the liquid crystal panel can be restored. Thus, the manufacturing yield can be improved.

Preferably, the reflection layer 302 has specular reflection power from the point of view of reflectance. In this embodiment, the reflection layer 302 is formed of an aluminum film by a vapor deposition method. A multi-layer film may be provided on the surface of the reflection layer 302 so as to improve the reflectance. The protective layer 303 is formed on the multi-layer film in order to protect the reflection layer 302 from being corroded and flatten the surface of the reflection layer 302.

Incidentally, the reflection layer is not limited to aluminum. A metal film of chromium, silver, or the like, or a non-metal film may be used if it has specular reflection power.

In addition, the protective film 303 is not limited to an SiO2 film. It will go well if the protective film 303 is an insulating film for protecting the reflection layer 302. The protective film 303 may be an inorganic film such as a silicon nitride film, or the like, an organic metal film such as an organic titanium film, or the like, or an organic film of polyimide, epoxy, or the like. Particularly, an organic film of polyimide, epoxy, or the like, is excellent in evenness so that the lower electrodes 304 can be formed on the protective film 303 easily. If an organic metal film such as an organic titanium film, or the like, is used as the protective film 303, the lower electrodes 304 can be formed at a high temperature. As a result, the wiring resistance of the lower electrodes 304 can be reduced.

Above the liquid crystal panel in which the multi-layer optical film 312 has been installed, a illuminator having a light guide plate 201 and a light source 202 is provided as a illuminator 200 which is used when external light is insufficient.

The light guide plate 201 is made of transparent resin such as acrylic resin or the like. A printed pattern or irregularities for making light L4 exit from the light source 202 toward the liquid crystal panel are given to the observer's side surface (upper surface) of the light guide plate 201.

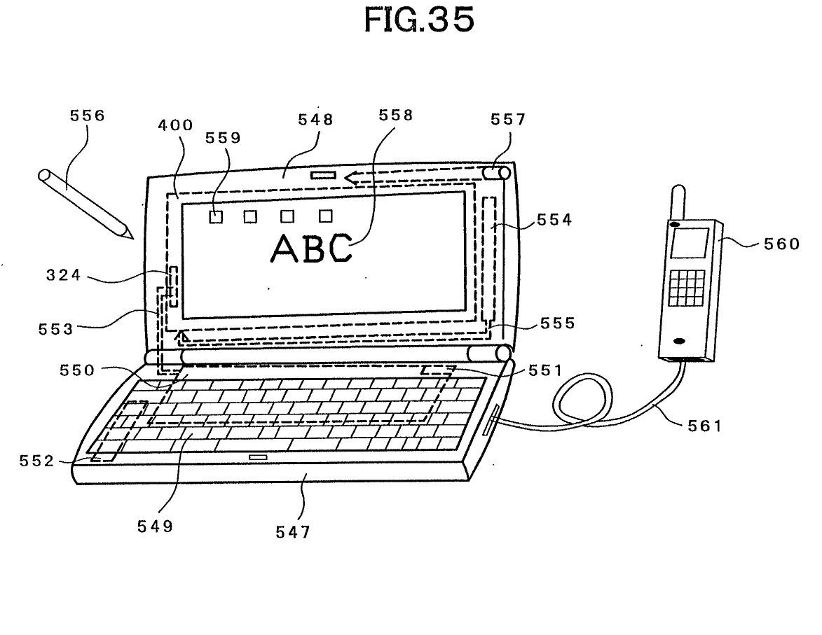

Further, a touch panel 100 is provided on the illuminator 200. When the surface of the touch panel 100 is pressed by an input operation tool (a sharp-pointed rod-like body such as a pen point), a fingertip, or the like, the touch panel 100 detects the position coordinates of the pressed portion, and outputs a data signal. The data signal is to be sent to a host system (550 in FIG. 35 which will be described later) of an information processing apparatus (547 in FIG. 35).

The second substrate 305 of the liquid crystal display unit 300, the light guide plate 201 of the illuminator 200, and the touch panel 100 are fixed through a double-faced adhesive tape (for example, non-woven fabric impregnated with an adhesive agent) or the like.

By use of the double-faced adhesive tape, the liquid crystal display unit 300, the illuminator 200 and the touch panel 100 stuck on one another can be peeled off. Thus, they can be restored even if they have been fixed by mistake.

Incidentally, the illuminator 200 is not an essential constituent. The illuminator 200 is not necessary when the display unit is always used in a bright environment.

In this embodiment, the adhesive layer 311a provided between the first phase difference plate 312c and the second phase difference plate 312d is set to have a light diffusion function. Specifically, a light diffusion material different in refractive index from an adhesive agent is mixed into the adhesive agent. When an epoxy or acrylic adhesive material is used, particles of transparent organic matter such as polyethylene, polystyrene, divinylbenzene, or the like, or particles of transparent inorganic matter such as silica, or the like, can be used as the light diffusion material.

Incidentally, an adhesive material having a different refractive index from that of the light diffusion material may be used as the aforementioned adhesive material. In such a case, the first phase difference plate 312c and the second phase difference plate 312d can be restored even if they are stuck by mistake.

When particles of transparent organic matter or particles of transparent inorganic matter are used as the light diffusion material, light absorption in a visible light range is reduced so that the reflectance or the spectral characteristic of the liquid crystal panel can be improved.

Further, when the adhesive agent is of organic matter, the difference in thermal expansion coefficient between the adhesive agent and the light diffusion material can be reduced if particles of organic matter are used as the light diffusion material. Thus, there is no fear that the adhesive layer 311a is cracked.

Incidentally, by mixing the light diffusion material into the adhesive agent, the adhesive layer is cracked more easily than an adhesive layer of only an adhesive material. However, the adhesive layer 311a containing the light diffusion material is inserted between the first phase difference plate 312c and the second phase difference plate 312d having substantially the same thermal expansion coefficient. As a result, the problem that the adhesive layer 311a is cracked can be avoided.

Next, the display principle of the configuration in FIG. 31 will be described. Incident light L1 entering the liquid crystal display unit 400 from various directions reaches the reflection layer 302 through the touch panel 100, the light guide plate 201 of the illuminator 200, the polarizing plate 312b, the adhesive layer 311 for fixing the polarizing plate 312b to the first phase difference plate 312c, the first phase difference plate 312c, the adhesive layer 311a having a light diffusion function for fixing the first phase difference plate 312c to the second phase difference plate 312d, the second phase difference plate 312d, the adhesive layer 311 for fixing the second phase difference plate 312d to the second substrate 305, the second substrate 305, the color filter 306, the upper electrode 308, the liquid crystal layer 309, and a specific pixel electrode (or a specific signal line) 304a.

The external light Li reaching the reflection layer 302 is reflected to form reflected light L2. The reflected light L2 follows a path reverse to that of the incident light L1, and reaches the adhesive layer 311a having a light diffusion function. The reflected light L2 incident on the adhesive layer 311a is scattered in various directions. Thus, scattered light L3 in various directions is produced.

The direct reflected light L2 or the scattered light L3 exiting from the adhesive layer 311a is released to the outside of the liquid crystal display unit 400 through the first phase difference plate 312c, the adhesive layer 311, the polarizing plate 312b, the light guide plate 201, and the touch panel 100. A phase difference appearing when the direct reflected light L2 or the scattered light L3 is transmitted through the liquid crystal layer 309 is compensated by the first phase difference plate 312c by use of its birefringence effect.

An observer views the direct reflected light L2 or the scattered light L3 released to the outside of the liquid crystal display unit. Thus, the observer can recognize a display controlled through the specific pixel electrode 304a.

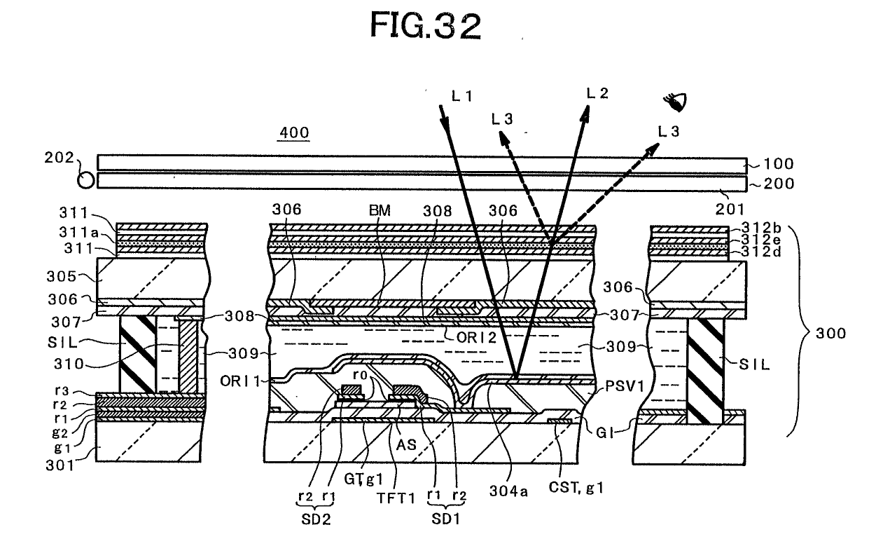

FIG. 32 is a sectional view for explaining another mode for carrying out a screen input type display unit according to the present invention. Parts having the same functions as those in FIG. 31 are referenced correspondingly. In this mode, a illuminator 200 similar to that described in FIG. 31 is laminated onto a liquid crystal display unit 300, and a touch panel 100 is installed on the illuminator 200. Thus, a screen input type liquid crystal display unit 400 is arranged.

The liquid crystal display unit 300 is a liquid crystal panel of a thin film transistor (TFT) type which is typical of an active matrix type. A plurality of pixels each having a thin film transistor TFT1 and a pixel electrode 304a are formed inside a first substrate 301 which constitutes the liquid crystal display unit 300.

Each pixel is disposed in a cross area defined by two adjacent scanning signal lines and two adjacent video signal lines. The thin film transistor TFT 1 is constituted by a first semiconductor layer (channel layer) AS provided on the first substrate 301, a second semiconductor layer (impurities-containing semiconductor layer) r0 provided on the first semiconductor layer AS, a source electrode SD1 and a drain electrode SD2 provided further on the second semiconductor layer r0. Here, the source electrode SD1 and the drain electrode SD2 are formed of a multi-layer film of conductive films r1 and r2. However, the source electrode SD1 and the drain electrode SD2 may be formed of a single-layer conductive film, that is, only the conductive film r1.

Incidentally, the relationship between the source electrode and the drain electrode is inverted in accordance with the way how to apply a voltage thereto, that is, the electrode SD2 serves as a source electrode and the electrode SD1 serves as a drain electrode. However, in the following description, the electrode SD1 is regarded as a source electrode and the electrode SD2 is regarded as a drain electrode for convenience's sake.

PSV1 represents an insulating film (protective film) for protecting the thin film transistor TFT1; 304a, a pixel electrode; ORI1 and ORI2, alignment films abutting against the first substrate 301 and the second substrate 305 respectively for aligning the liquid crystal layer 309; and 308, an upper electrode (common electrode).

A light shield film BM which is also called a black matrix has a function to shield light between adjacent pixel electrodes 304a so as to improve contrast. A conductive film 310 electrically connects the upper electrode 308 with terminals (multi-layer metal conductive films g1, g2, r1, r2 and r3) provided on the first substrate 301.

When a selected voltage is applied to a gate line electrode GT, conduction is made between the source electrode SD1 and the drain electrode SD2. Thus, the thin film transistor TFT1 functions as a switch in the same manner as an insulated-gate type field-effect transistor.

The pixel electrode 304a is connected to the source electrode SD1. The video signal line of the pixel 304 is connected to the drain electrode SD2 while the scanning signal line is connected to a gate electrode GT. A specific pixel electrode 304a is selected by a selected voltage applied to the scanning signal line, and a gradation voltage applied to the video signal line is supplied to the specific pixel electrode 304a. A capacitive electrode CTS formed of the conductive film g1 has a function to hold the gradation voltage supplied to the pixel electrode 304a till the next selection time comes.

Such an active matrix type liquid crystal display unit 300 has a switching element such as a thin film transistor or the like for every pixel. Accordingly, there is no problem that crosstalk is produced between different pixels, and it is not necessary to suppress crosstalk by special driving of a voltage averaging method or the like. It is therefore possible to achieve a multi-gradation display easily. In addition, the active matrix type liquid crystal display unit 300 has a feature that the contrast is not lowered even if the number of scanning lines is increased. The liquid crystal panel is not limited to the above-mentioned configuration. So-called polysilicon semiconductors may be used for the liquid crystal panel.

In this embodiment, the pixel electrode 304a is formed of a reflective metal film of aluminum, chromium, titanium, tantalum, molybdenum, silver, or the like. In addition, the protective film PSV1 is provided between the pixel electrode 304a and the thin film transistor TFT1. Accordingly, it is possible to realize a high-reflectance liquid crystal panel in which there is no fear of malfunction even if the pixel electrode 304a is enlarged to overlap the thin film transistor TFT1.

Further, in this liquid crystal panel, the first phase difference plate in the liquid crystal panel of the type described in FIG. 31 is not provided, but a third phase difference plate 312e is provided to improve the viewing angle characteristic. The third phase difference plate 312e is also called a viewing angle extension film, which improves the angle dependency of the display characteristic of the liquid crystal panel by use of the birefringence characteristic.

The third phase difference plate 312e can be formed of an organic resin film of polycarbonate, polyacrylate, polysulfone, or the like. Accordingly, by using the light diffusion adhesive layer 311a as an adhesive layer for fixing the third phase difference plate 312e to the second phase difference plate 312d, it is possible to prevent the light diffusion adhesive layer 311a from being cracked.

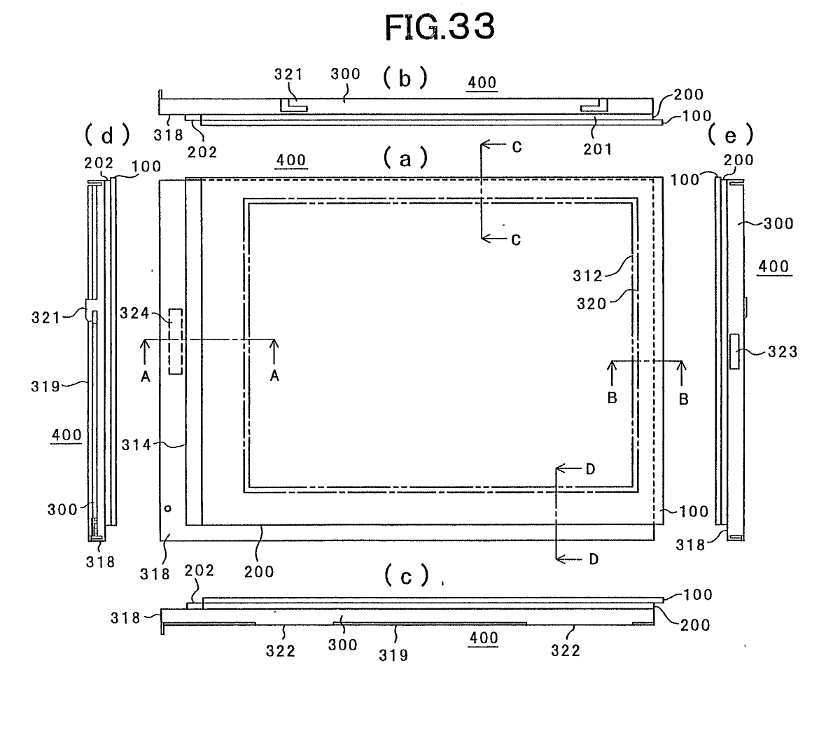

FIG. 33 has five views (a) to (e) for explaining the external appearance of the screen input type display unit according to the present invention. View (a) is a front view from the display surface side; view (b), an upper side view; view (c), a lower side view; view (d), a left side view; and view (e), a right side view.

In views (a) to (e) of FIG. 33, an upper case (shield case) 318 is made of a metal plate of stainless steel, iron, aluminum, or the like. The upper case 318 is provided with first openings 320 as display windows. A lower case 319 is made of a metal plate of stainless steel, iron, aluminum, or the like, or plastic such as polycarbonate, ABS resin, or the like.

The upper case 318 is provided with claws 321 and hooks 322. The lower case 319 is retained by the claws 321 and the hooks 322 so that the upper case 318 is coupled with the lower case 319.

A light system 200 (herein, a front light) for illuminating the liquid crystal display unit 300 when external light is insufficient is constituted by a light guide plate 201 and a light source (lamp) 202 such as a fluorescent lamp, an LED, or the like. The light guide plate 201 is made of a transparent material such as acrylic resin, glass, or the like. The reference numeral 100 represents a touch panel for inputting data to be sent to a host system (information processing portion) connected to the liquid crystal display unit 400.

Optical films 312 such as a light diffusion layer, a polarizing plate, a phase difference plate, etc. are provided in the display portion of the liquid crystal display unit 400. The optical films 312 are provided to fall within the region of the opening of the upper case 318 so as to reduce the thickness of the liquid crystal display unit 400 as a whole.

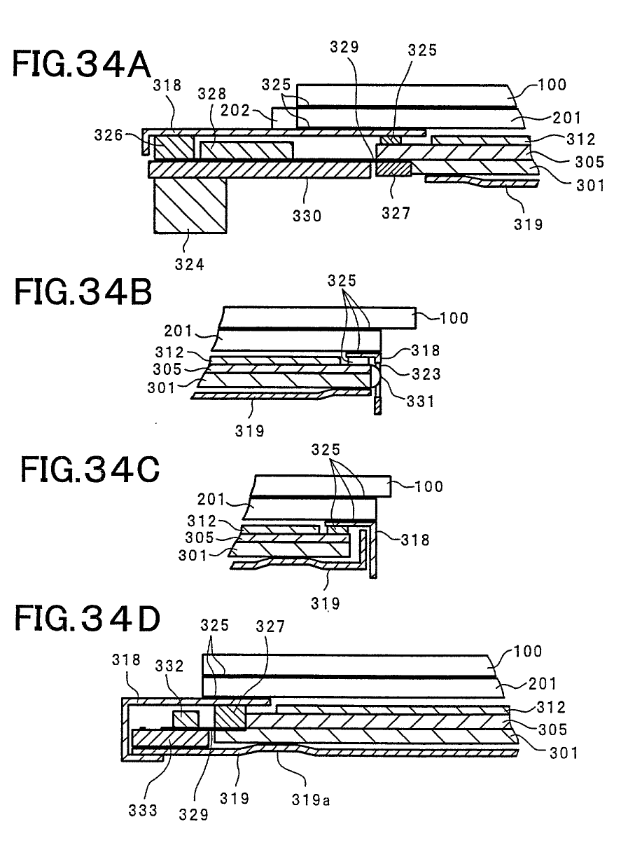

FIGS. 34A to 34D are main portion sectional views of FIG. 33. FIG. 34A is a sectional view taken on line A-A in view (a) of FIG. 33; FIG. 34B, a sectional view taken on line B-B in view (a) of FIG. 33; FIG. 34C, a sectional view taken on line C-C in view (a) of FIG. 33; and FIG. 34D, a sectional view taken on line D-D in view (a) of FIG. 33.

In the liquid crystal panel, after liquid crystal is injected into the gap with which the first and second substrates 301 and 305 have been panel-aligned with each other, the injection hole is sealed down with a sealer 331. An opening 323 is provided in the upper case 318 correspondingly to the sealer 331 so as to prevent the outer dimensions of the liquid crystal panel from increasing even if the sealer projects outward.

A printed board (scanning line driving PCB) 330 mounted with a scanning line driving IC chip 328 for driving a scanning line is installed in the periphery of the first and second substrates 301 and 305. The printed board 330 is connected to the liquid crystal panel through a flexible printed board 329.

In addition, a printed board (signal line driving PCB) 333 mounted with a signal line driving IC chip 332 for driving a signal line is installed in the periphery of the first and second substrates 301 and 305. The printed board 333 has the flexible printed board 329 connected to the liquid crystal panel.

Various signals and voltages for display are supplied from an external circuit (host system) to the scanning line driving PCB 330 and the signal line driving PCB 333 through an interface connector 324. Incidentally, the interface connector 324 is provided in the scanning line driving PCB 330. However, the interface connector 324 may be provided in the signal line driving PCB 333.

A spacer 326 fixes the scanning line driving PCB 330, while a spacer 327 retains a connection portion between the scanning line driving PCB 330 and the signal line driving PCB 333 and a connection portion between the scanning line driving PCB 330 and the liquid crystal panel. The spacers 326 and 327 are formed of an insulating elastic material such as rubber or the like.

The reference numeral 325 represents a double-faced adhesive tape. For example, non-woven fabric impregnated with an epoxy adhesive agent can be used as the double-faced adhesive tape 325. By use of the double-faced adhesive tape 325, the upper case 318 is fixed to the liquid crystal panel, the upper case of the liquid crystal panel is fixed to the light guide plate 201 of the illuminator 200, and the light guide plate 201 of the illuminator 200 is fixed to the touch panel 100.

In such a manner, by fixing the auxiliary light source system and the touch panel to the liquid crystal panel through the double-faced adhesive tape 325, the assembly work is simplified, and restoration of the constituent members in case of erroneous assembly becomes easy. Thus, the manufacturing yield is improved.

In the lower case 319 which incorporates the liquid crystal panel together with the upper case 318, a convex portion 319a projecting inward is formed. The liquid crystal panel is suppressively retained by the convex portion 319a.

FIG. 35 is an explanatory view of an example of an information processing apparatus using a screen input type display unit according to the present invention. This information processing apparatus is also termed a so-called portable information terminal, which is constituted by a body portion 547 and a display portion 548. The body portion 547 has a keyboard 549, a host system (information processing portion) 550 including a microcomputer 551, and a battery 552.

The display portion 548 is mounted with the depression input type liquid crystal display unit 400 described previously. Characters or graphics 558 are inputted to a touch panel exposed in the display portion by a pen 556 stored in a pen storage portion 557. Alternatively, an icon 559 is selected by the pen 556.

In addition, the display portion 548 is mounted with an inverter power supply 554 for supplying lighting power to an auxiliary light source system through a cable 555.

Signals or voltages for display from the body portion are supplied through an interface cable 553 to the interface connector 324 of the liquid crystal panel constituting the liquid crystal display unit 400 mounted on the display portion 548.

Further, this information processing apparatus can make a connection with a portable telephone 560 through a cable 561. Thus, the information processing apparatus can make a connection with an information communication network such as Internet or the like, so as to have communication therewith.

Thus, by use of the screen input type display unit according to the present invention, the information processing apparatus is reduced in size and weight so that the usability can be improved.

Incidentally, the shape or structure of such a portable information terminal is not limited to the illustrated one. It may be considered that the portable information terminal can take various shapes, various structures and various functions other than the illustrated one.

As has been described above, according to the present invention, a touch panel for use in a screen input type display unit can avoid display distortion or an input error caused by the protuberance of a region where an output line to be extracted between upper and lower substrates, that is, where an output printed board is installed. In addition, the total size of the touch panel is prevented from increasing. Accordingly, the touch panel is reduced in size and weight as a whole, and has a narrow frame. Thus, the viewing area of an input region is enlarged easily. In addition, a resistance film formed on the upper substrate or the upper substrate itself is prevented from damage caused by repeated input operations. Thus, it is possible to provide a high-reliability screen input type display unit. In addition, it is possible to realize a manufacturing method in which the productivity is excellent and it is possible to prevent contamination of foreign matters.

What is claimed is

1. A method for manufacturing a touch panel, comprising the steps of:
adhering an upper substrate and a lower substrate with each other, said upper substrate being made of a soft film member with an upper resistance film, said lower substrate being made of a hard plate with a lower resistance film; and
subsequently cutting off said upper substrate and said lower substrate.

2. A method for manufacturing a touch panel according to claim 1, wherein said lower substrate is made of a glass plate or a plastic plate.

3. A method for manufacturing a touch panel according to claim 1, wherein said lower substrate is cut off after said upper substrate is cut off.

4. A method for manufacturing a touch panel according to claim 3, wherein after said upper substrate is cut off by a first blade, said first blade is replaced by a second blade for cutting off said lower substrate, and then said lower substrate is cut off.

5. A method for manufacturing a touch panel according to claim 1, wherein said upper substrate and said lower substrate are cut off simultaneously.

6. A method for manufacturing a touch panel according to any one of claims 1, wherein said lower substrate is cut off from the side of said upper substrate.

7. A method for manufacturing a touch panel according to any one of claims 1, wherein said lower substrate is cut off from a side opposite to said upper substrate.

8. A method for manufacturing a touch panel according to any one of claims 1, wherein a first base material which will be cut off to obtain a plurality of said upper substrates and a second base material which will be cut off to obtain a plurality of said lower substrates are adhered to each other, and subsequently said first base material and said second base material are cut off.

9. A method for manufacturing a touch panel according to any one of claims 1, wherein:
said touch panel has said upper substrate, said lower substrate and an output printed board for extracting output signals;
said lower substrate has lower wiring electrode leading wires and upper wiring electrode leading wires, said lower-wiring electrode leading wires being electrically connected to said lower resistance film and extending to a leader line connection region of an outer circumferential end portion of an input region, said upper wiring electrode leading wires being electrically connected to said upper resistance film and extending to said leader line connection region;
said lower wiring electrode leading wires and said upper wiring electrode leading wires are connected to said output printed board in said leader line connection region; and
at least a portion of said upper substrate corresponding to said leader line connection region is removed.

10. A method for manufacturing a touch panel according to claim 9, wherein before said upper substrate and said lower substrate are adhered to each other, at least said portion of said upper substrate corresponding to said leader line connection region is removed.

11. A method for manufacturing a touch panel according to claim 9, wherein after said upper substrate and said lower substrate are adhered to each other, at least said portion of said upper substrate corresponding to said leader line connection region is removed.

12. A method for manufacturing a touch panel according to claim 9, wherein before said upper substrate and said lower substrate are cut off, said upper substrate and said lower substrate are connected to said output printed board.

13. A method for manufacturing a touch panel according to claim 9, wherein after said upper substrate and said lower substrate are cut off, said upper substrate and said lower substrate are connected to said output printed board.

14. A method for manufacturing a touch panel according to any one of claims 9, wherein spacers 2 to 20 μm high are formed on said lower resistance film of said lower substrate by a printing method.

15. A touch panel comprising:
an upper substrate having an upper resistance film;
a lower substrate having a lower resistance film; and
an output printed board for extracting output signals;
wherein said lower substrate has lower wiring electrode leading wires and upper wiring electrode leading wires, said lower wiring electrode leading wires being electrically connected to said lower resistance film and extending to a leader line connection region of an outer circumferential end portion of an input region, said upper wiring electrode leading wires being electrically connected to said upper resistance film and extending to said leader line connection region;
wherein said lower wiring electrode leading wires and said upper wiring electrode leading wires are connected to said output printed board in said leader line connection region; and
wherein a portion of said upper substrate corresponding to said leader line connection region is removed to follow a shape of an installation portion of said output printed board.

16. A touch panel comprising:
an upper substrate having an upper resistance film;
a lower substrate having a lower resistance film; and
an output printed board for extracting output signals;
wherein said lower substrate has lower wiring electrode leading wires and upper wiring electrode leading wires, said lower wiring electrode leading wires being electrically connected to said lower resistance film and extending to a leader line connection region of an outer circumferential end portion of an input region, said upper wiring electrode leading wires being electrically connected to said upper resistance film and extending to said leader line connection region;
wherein said lower wiring electrode leading wires and said upper wiring electrode leading wires are connected to said output printed board in said leader line connection region;
wherein a part or all of said lower wiring electrode leading wires and said upper wiring electrode leading wires are laid to be drawn into a side surface of said output printed board along a side of said lower substrate where said leader line connection region exists; and
wherein a side of said upper substrate where at least a portion corresponding to said leader line connection region exists is wholly removed.

17. A screen input type display unit in which a touch panel is installed on a display surface of said display unit, wherein: said touch panel has an upper substrate having an upper resistance film, a lower substrate having a lower resistance film, and an output printed board for extracting output signals;
said lower substrate has lower wiring electrode leading wires and upper wiring electrode leading wires, said lower wiring electrode leading wires being electrically connected to said lower resistance film and extending to a leader line connection region of an outer circumferential end portion of an input region, said upper wiring electrode leading wires being electrically connected to said upper resistance film and extending to said leader line connection region;
said lower wiring electrode leading wires and said upper wiring electrode leading wires are connected to said output printed board in said leader line connection region; and
a portion of said upper substrate corresponding to said leader line connection region is removed to follow a shape of an installation portion of said output printed board.

18. A screen input type display unit according to claim 17, wherein at least a part of said lower wiring electrode leading wires and said upper wiring electrode leading wires of said lower substrate are laid to be drawn into a side surface of said output printed board along a side of said lower substrate where said leader line connection region exists.

19. A screen input type display unit according to claim 17, wherein an end surface of said upper substrate is located correspondingly to an end surface of said lower substrate.

20. A screen input type display unit according to any one of claims 17, wherein said upper substrate and said lower substrate are opposed to each other through spacers 2 to 20 μm high.

21. A screen input type display unit in which a touch panel is installed on a display surface of said display unit, wherein: said touch panel has an upper substrate having an upper resistance film, a lower substrate having a lower resistance film, and an output printed board for extracting output signals; said lower substrate has lower wiring electrode leading wires and upper wiring electrode leading wires, said lower wiring electrode leading wires being electrically connected to said lower resistance film and extending to a leader line connection region of an outer circumferential end portion of an input region, said upper wiring electrode leading wires being electrically connected to said upper resistance film and extending to said leader line connection region;
said lower wiring electrode leading wires and said upper wiring electrode leading wires are connected to said output printed board in said leader line connection region;
a part or all of said lower wiring electrode leading wires and said upper wiring electrode leading wires are laid to be drawn into a side surface of said output printed board along a side of said lower substrate where said leader line connection region exists; and
a side of said upper substrate where at least a portion corresponding to said leader line connection region exists is wholly removed.

22. A screen input type display unit according to claim 21, wherein said upper substrate and said lower substrate are opposed to each other through spacers 2 to 20 μm high.
